(19) United States
(12) Patent Application Publication
(10) Pub. No.: US 2004/0152821 A1
(43) Pub. Date: Aug. 5, 2004

(54) Polymer composition

(76) Inventors: Kazunori Saegusa, Hyogo (JP); Toru Terada, Hyogo (JP); Koji Yui, Hyogo (JP); Mamoru Kadokura, Hyogo (JP)

Correspondence Address: Brinks Hofer Gilson & Lione, PO Box 10395, Chicago, IL, 60610, US

(21) Appl. No.: 10/480,318

(22) PCT Filed: Jun. 6, 2002
(86) PCT No.: PCT/JP02/05578

(30) Foreign Application Priority Data
Jun. 11, 2001 (JP) 2001-176064

(51) Int. Cl. C08K 3/20

(52) U.S. Cl. 524/458

(57) ABSTRACT

A vinyl chloride resin composition which provides, with a small load on the molding machine, a product excellent in impact resistance, gelation properties and heat stability, and in addition, having superior appearance and dimensional stability is provided. In particular, a core-shell polymer composition for modifying vinyl chloride resin, which provides the vinyl chloride resin composition, is provided. The core-shell polymer composition for vinyl chloride resin composition comprises (A) 85 to 99.5 % by weight of a core-shell polymer containing a rubbery polymer and (B) 15 to 0.5 % by weight an acid or anionic surfactant, and the core-shell polymer composition has a specific viscosity (ηₛₚ) of at least 0.1 when measured at 30° C. by using a 0.2 g/100 ml acetone solution of a portion soluble in methyl ethyl ketone and insoluble in methanol of said core-shell polymer composition.

### TECHNICAL FIELD

The present invention relates to a vinyl chloride resin composition. More specifically, the invention relates to a vinyl chloride resin composition which has excellent weatherability, impact resistance, and good extrusion processability. Furthermore, the present invention relates to a graft copolymer composition for modifying vinyl chloride resin to provide the vinyl chloride resin composition, and a process for preparing the same.

### BACKGROUND ART

Molded articles prepared from vinyl chloride resin have good mechanical and chemical properties and are widely used in various fields. However, impact resistance is insufficient when using only vinyl chloride resin and the temperature range at which molding is possible is limited, due to the processing temperature being close to the thermal decomposition temperature. In addition to these, there is also the flaw of needing a long time to reach the melting stage.

Many methods to improve the aforesaid problem of insufficient impact resistance have been proposed. Among these, the methods of compounding MBS. resin or ABS resin, obtained by graft copolymerizing methyl methacrylate and styrene, or acrilonitrile and styrene with a butadiene rubber polymer, are widely used.

However, when MBS resin or ABS resin is mixed with vinyl chloride resin, though the impact resistance is improved, the weatherability decreases and there is the flaw of impact resistance decreasing significantly when the molded article produced is used out of doors. So in order to improve the weatherability and provide impact resistance to MBS resin, the method of graft polymerizing methyl methacrylate, aromatic vinyl compound and unsaturated nitrile with an alkyl acrylate rubbery polymer, which does not contain any double bonds within the polymer, has been proposed (JP-B-51-28117, JP-B-57-8827).

When the graft copolymer of the above method is used, the vinyl chloride resin molded article that is produced is excellent in weatherability and can be used in the architectural field which requires weatherability over a long period, particularly as window frames and siding material. However, though the blend of these graft copolymers demonstrate a significant effect in the improvement of the impact resistance of the vinyl chloride resin, a sufficient effect cannot be expected in the processability, especially in the promotion of gelation. And in some cases impact resistance, an original characteristic, was not sufficiently demonstrated due to faulty gelation depending on the compounding conditions or molding conditions.

In this way, in recent years, the gelation state of vinyl chloride resin has begun to be emphasized as an important factor concerning the impact resistance of products of vinyl chloride resin. As an example, in profile extrusion molding, the impact resistance of the molded article is significantly influenced by the degree of gelation and faulty gelation in low temperature molding is known to be the reason for decreased impact resistance.

This sort of problem of faulty gelation is often attempted to be solved by changing the molding conditions such as by raising the molding temperature or applying high mechanical shearing. However, when the molding temperature is raised, strength reduction, presumably based on an increase in yield stress, is brought about. Not only this but a decrease in long running, due to a decrease in heat stability, a degradation in the color tone of the molded article, development of burning and the like, also tends to arise. When high mechanical shearing is applied, heat generation by shearing of the molded resin increases, bringing about a decrease in heat stability and a degradation in the color tone of the molded article. This also brings about a decrease in production efficiency, as the molding machine suffers from a heavy load.

In order to solve these problem arising from the gelation of vinyl chloride resin without applying a large change to the molding conditions, the method of compounding approximately 0.5 to 5% of a copolymer containing methyl methacrylate as the main component as a processing aid has been disclosed (JP-B-52-49020). This method is considered to be the most effective in the art of improving the gelation of vinyl chloride resin. By compounding this processing aid, the geltaion of the vinyl chloride resin is improved, the torque and die pressure when extrusion molding is lowered, and improvement of productivity becomes possible.

However, though this processing aid advances the gelation of the vinyl chloride resin when mold processing, it often accompanies a decrease in impact resistance. This tendency becomes more noticeable the more the processing aid is used. The decrease in impact resistance of the vinyl chloride resin is presumed to be because of an increase in the modulus and yield stress, due to a great deal of methyl methacrylate units contained within the composition of the polymer. In order to prevent the decrease in impact resistance, reducing the amount of the processing aid introduced is preferable, but the balance between gelation and impact resistance becomes difficult. Furthermore, in order to fulfill impact resistance while using an amount of processing aid necessary to fulfill gelation properties, the problem of needing to use a great deal of the aforesaid graft polymer arises. In some cases, the adding of a methyl methacrylate processing aid may trigger problems such as a decrease in dimensional stability due to shrinking of the molded article after molding and damage to the appearance of the molded article due to melt fracture when extrusion molding. This is thought to be because the melt elasticity of the vinyl chloride resin increases significantly due to the adding of a methyl methacrylate processing aid. In addition, other problems mentioned above, that is a decrease in heat stability due to an increase in heat generation by shearing of the melted resin and a decrease in production efficiency as the molding machine suffers from a heavy load, cannot yet be solved to a satisfactory degree.

With the purpose of preventing problems such as a decrease in impact resistance and the development of melt fracture due to a processing aid and demonstrating a balance between impact resistance and gelation properties when mold processing the vinyl chloride resin, the method of using a graft copolymer which has extremely high molecular weight graft chains as the aforesaid graft polymer has been disclosed (JP-A-4-33907, JP-A-5-132600). In these disclosures, by compounding a graft copolymer which has extremely high molecular weight graft chains to the vinyl chloride resin, the gelation properties are improved and the degree of kneading of the molded article to be obtained is increased, and by this, the secondary processability of the molded article is improved. Furthermore, the fact that good impact resistance can be obtained at the same time because a rubbery elastic body is contained within the graft copolymer is disclosed. However, though significant improvement can be seen in comparison to the case of using a processing aid, there are cases of deficient appearance developing due to melt fracture just as before. In addition, other problems mentioned above, that is a decrease in heat stability due to an increase in heat generation by shearing of the melted resin and a decrease in production efficiency, as the molding machine suffers from a heavy load, cannot yet be solved to a satisfactory degree and further improvement is desired.

And so, the method of introducing a great deal of stabilizers to prevent a decrease in heat stability is widely known and the method of using a great deal of lubricant to reduce the load on the molding machine is widely used. However, because these methods trigger problems such as plate-out and make gelation properties worse, there was the problem of canceling the gelation improvement effect of the methyl methacrylate processing aid or graft copolymer which has extremely high molecular weight graft chains.

When molding into a calendar sheet having impact resistance, in order to improve the peeling properties of the vinyl chloride resin from the roll surface, the method of adding an anionic surfactant within the range of 2 parts by weight (based on the graft polymer) to a vinyl chloride resin composition which contains a graft copolymer such as MBS resin is disclosed (JP-A-10-087934). However, in the aforesaid publication, though the effect regarding the peeling properties between the roll surface and resin in calendar molding and heat roll molding is described, the effect of decreasing the load of the molding machine when extrusion molding is not mentioned at all. The method of obtaining a molded article with superior impact resistance by extrusion molding is not mentioned at all as well. In truth, when the vinyl chloride resin composition of the aforesaid publication is subjected to extrusion molding under realistic conditions, obtaining a molded article with sufficient impact resistance is difficult. This is thought to be because the gelation properties when extrusion molding were not sufficiently improved as the molecular weight of the chain of the graft copolymer of the aforesaid publication is not very high, and thus the gelation does not progress to a degree sufficient for demonstrating good impact resistance.

The development of a resin composition which solves this series of problems, that is a resin composition superior in weatherability, impact resistance, gelation properties and heat stability, at the same time presenting a small load to the molding machine and superior in product appearance, is extremely significant industrially. Furthermore, the development of a modifier for vinyl chloride resin, which can provide a vinyl chloride resin composition solving the aforesaid problems, is also extremely significant industrially.

### DISCLOSURE OF INVENTION

The present invention has been made in view of the above problems, and the object of the present invention is to provide a vinyl chloride resin composition which is excellent in impact resistance, gelation property and heat stability with reduced load on the molding machine, and which can provide a product of excellent appearance and dimensional stability.

As a result of intensive studies, it has been found that the above problems can be solved by using a core-shell polymer containing a portion having a specific ηₛₚ, in combination with a specific acid or anionic surfactant, and the present invention has been accomplished.

In the present invention, a core-shell polymer comprising a rubbery polymer is used in order to attain excellent impact resistance of the vinyl chloride resin composition to be obtained, and for exhibiting good gelation properties at the same time, a core-shell polymer in which the molecular weight of the portion soluble in MEK is greatly increased is used. The present invention has been completed based on the findings that only when such core-shell polymer and a limited kind of acid or anionic surfactant are combined and mixed to the vinyl chloride resin, the load on the molding machine can be greatly reduced without affecting impact resistance or decreasing gelation property improving effect by the high molecular weight polymer of the core-shell polymer, while those effects are sufficiently exhibited.

That is, the present invention relates to a core-shell polymer composition comprising:

(A) 85 to 99.4% by weight of a core-shell polymer containing a rubbery polymer having a glass transition temperature of at most 0° C. in the core or the shell,

(B) 15 to 0.6% by weight of at least one acid or anionic surfactant sulfofatty acid ester, alkyl sulfonates, alkyl phosphates or salts thereof and alkyl phosphites or salts thereof ((A) and (B) amounting to 100% by weight in total),

the core-shell polymer having a specific viscosity (ηₛₚ) of at least 0.19 when measured at 30° C. by using a 0.2 g/100 ml acetone solution of a portion soluble in methyl ethyl ketone and insoluble in methanol of the core-shell polymer.

The glass transition temperature of the rubbery polymer is preferably at most −20° C.

It is preferable that the core of the core-shell polymer (A) is a rubbery polymer obtained by polymerizing a monomer mixture comprising 45 to 99.95% by weight of alkyl acrylate, which has an alkyl group having 2 to 18 carbon atoms, 0 to 40% by weight of alkyl methacrylate, which has an alkyl group having 4 to 22 carbon atoms, 0.05 to 5% by weight of a multifunctional monomer and 0 to 10% by weight of a monomer copolymerizable therewith (100% by weight in total).

It is preferable that the core of the core-shell copolymer (A) is a rubbery polymer obtained by polymerizing a monomer mixture comprising 95 to 99.9% by weight of alkyl acrylic ester, which has an alkyl group having 2 to 12 carbon atoms, and 0.1 to 5% by weight of a multifunctional monomer (100% by weight in total).

It is preferable that at least one shell layer of the core-shell polymer (A) is a polymer obtained by polymerizing a monomer or monomer mixture comprising:

40 to 100% by weight of methyl methacrylate,

0 to 60% by weight of at least one monomer or monomer mixture selected from the group consisting of alkyl acrylate, which has an alkyl group having 1 to 18 carbon atoms, alkyl methacrylate, which has an alkyl group having 2 to 18 carbon atoms, unsaturated nitrile and aromatic vinyl compound, and

0 to 10% by weight of a monomer copolymerizable therewith.

It is preferable that at least one shell layer of the core-shell polymer (A) is a polymer obtained by polymerizing a monomer or monomer mixture comprising:

40 to 100% by weight of methyl methacrylate, and

0 to 60% by weight of at least one monomer or monomer mixture selected from the group consisting of alkyl acrylate, which has an alkyl group having 1 to 12 carbon atoms, and alkyl methacrylate, which has an alkyl group having 2 to 8 carbon atoms.

It is preferable that the portion soluble in methyl ethyl ketone and insoluble in methanol has a specific viscosity of 0.2 to 1 when measured in 0.2 g/100 ml acetone solution at 30° C.

It is preferable that the amount of the portion soluble in methyl ethyl ketone and insoluble in methanol is at least 2% by weight based on 100% by weight of the core-shell polymer (A).

It is preferable that the core-shell polymer (A) is a polymer obtained by polymerizing at least one monomer or monomer mixture for the shell in one step or at least two steps in the presence of a core polymer which is in latex state.

The alkyl group of the acid or anionic surfactant (B) is preferably a saturated or unsaturated hydrocarbon group having 8 to 20 carbon atoms.

It is preferable that the acid or anionic surfactant (B) is higher alcohol sulfate.

It is preferable that the acid or anionic surfactant (B) is dialkyl sulfosuccinate.

It is preferable that the acid or anionic surfactant (B) is acidic alkylpolyoxyalkylene phosphate.

It is preferable that the acid or anionic surfactant (B) is an alkali metal salt or an ammonium salt.

It is preferable that the acid or anionic surfactant (B) is contained in an amount of 1 to 12% by weight.

It is preferable that the acid or anionic surfactant (B) is contained in an amount of 2.3 to 10% by weight.

It is preferable that the acid or anionic surfactant (B) is contained in an amount of 2.8 to 8.5% by weight.

The present invention also relates to a process for preparing the core-shell polymer composition, which comprises conducting emulsion-polymerization by using the acid or anionic surfactant (B) to obtain the core-shell polymer (A).

In addition, the present invention relates to a process for preparing the core-shell polymer composition, which comprises carrying out coagulation or spray drying after adding the acid or anionic surfactant (B) to the core-shell copolymer (A) which is in a latex state.

Furthermore, the present invention relates to a process for preparing the core-shell polymer composition, which comprises mixing the acid or anionic surfactant (B) to the core-shell copolymer (A) which is in a state of powder or pellet.

The present invention also relates to a vinyl chloride resin composition comprising 1 to 30 parts by weight of the core-shell copolymer composition based on 100 parts by weight of a vinyl chloride resin (C).

The present invention also relates to a product obtained by molding the vinyl chloride resin composition.

### BEST MODE FOR CARRYING OUT THE INVENTION

In the present invention, one of the biggest characteristics lies in using a core-shell polymer having a specific molecular weight as the polymer for the shell or core, and a specific kind and amount of acid or anionic surfactant, together with a vinyl chloride resin. When the vinyl chloride resin is melt molded, the gelation advancing effect of the vinyl chloride resin by the high molecular weight polymer component of the core-shell polymer and the effect of decreasing friction between the metal surface of the molding machine and the melted vinyl chloride resin and/or the effect of decreasing intermolecular friction within the melted resin due to the acid or anionic surfactant sufficiently contribute in a balanced manner. In this respect, a vinyl chloride composition demonstrating excellent weatherability and impact resistance, as well as good extrusion processability can be provided.

The core-shell polymer composition of the present invention, as mentioned above is a core-shell polymer composition which comprises

(A) 85 to 99.4% by weight of a core-shell polymer containing a rubbery polymer having a glass transition temperature of at most 0° C. in the core or the shell,

(B) 15 to 0.6% by weight of at least one acid or anionic surfactant selected from the group consisting of alkyl sulfates, salts of alkyl sulfofatty acid ester, alkyl sulfonates, alkyl phosphates or salts thereof and alkyl phosphites or salts thereof

and has a specific viscosity (ηₛₚ) of at least 0.19 when measured at 30° C. by using a 0.2 g/100 ml acetone solution of a portion soluble in methyl ethyl ketone and insoluble in methanol of the core-shell polymer.

The core-shell polymer (A) used in the present invention is a core-shell type copolymer which has a core or shell containing a rubbery polymer. A core-shell polymer is obtained by conducting polymerization of a polymer which is to be the shell, in one step or at least two steps in the presence of a polymer which is to be the core. When compounded to vinyl chloride resin and then molded, the rubbery polymer exists dispersed in the obtained molded article. It is considered that the lower the modulus of the rubbery polymer is, the more susceptible to stress concentration under impact, bringing about a change in stress distribution of the matrix, and as a result, the rubbery polymer has the function of improving the impact resistance of the vinyl chloride resin molded article. Generally, modulus tends to be lower in the case of a rubber of a low glass transition temperature (Tg), and therefore the effect of improvement for impact resistance is considered to be higher in rubbery polymer of a low Tg. Consequently, as the rubbery polymer, those with a Tg of at most 0° C., more preferably at most −20° C., are used. When Tg exceeds 0° C., the impact resistance of the final molded article decreases.

The composition of the rubbery polymer of the core is not particularly limited as long as it has the aforesaid Tg. However, in order to provide a graft copolymer composition with good weatherability, the copolymer preferably is obtained by polymerizing at least one kind of alkyl acrylate, which has an alkyl group having 2 to 18 carbon atoms, at least one kind of alkyl methacrylate, which has an alkyl group having 4 to 22 carbon atoms, a multifunctional monomer and a monomer copolymerizable therewith.

This alkyl acrylic ester is a main component which defines the Tg of the rubbery polymer. Examples of the alkyl acrylic ester are ethyl acrylate, propyl acrylate, n-butyl acrylate, iso-butyl acrylate, n-hexyl acrylate, n-heptyl acrylate, n-octyl acrylate, 2-methylheptyl acrylate, 2-ethylhexyl acrylate, n-nonyl acrylate, 2-methyloctyl acrylate, 2-ethylheptyl acrylate, n-decyl acrylate, 2-methylnonyl acrylate, 2-ethyloctyl acrylate, lauryl acrylate, myristyl acrylate, cetyl acrylate, stearyl acrylate, amyl acrylate, 3,5,5-trimethylhexyl acrylate, ethoxyethyl acrylate, methoxytripropyleneglycol acrylate, 2-hydroxypropyl acrylate, 3-methoxypropyl acrylate, 4-hydroxybutyl acrylate and the like, but not limited to these. These monomers may be used alone or by mixing two or more kinds.

The alkyl methacrylic ester is also a component which defines the Tg of the rubbery polymer just as alkyl acrylic ester, and is a component used primarily for attaining a low Tg synergistically by using together with alkyl acrylic ester. Examples of the alkyl methacrylic ester are n-butyl methacrylate, iso-butyl methacrylate, n-hexyl methacrylate, cyclohexyl methacrylate, n-heptyl methacrylate, n-octyl methacrylate, 2-methylheptyl methacrylate, 2-ethylhexyl methacrylate, n-nonyl methacrylate, 2-methyloctyl methacrylate, 2-ethylheptyl methacrylate, n-decyl methacrylate, 2-methylnonyl methacrylate, 2-ethyloctyl methacrylate, lauryl methacrylate, cyclododecyl methacrylate, myristyl methacrylate, cetyl methacrylate, stearyl methacrylate, arachidyl methacrylate, behenyl methacrylate, 3-methoxypropyl methacrylate and the like, but not limited to these. These monomers may be used alone or by mixing two or more kinds.

The multifunctional monomer is a component used to form the crosslinked structure of the rubbery polymer. Examples of the multifunctional monomer are divinylbenzene, allyl acrylate, allyl methacrylate, alkylene glycol diacrylates such as ethylene glycol diacrylate; alkylene glycol dimethacrylates such as ethylene glycol dimethacrylate; polyoxyalkylene diacrylates such as polyethylene glycol diacrylate; polyoxyalkylene dimethacrylates such as polyethylene glycol dimethacrylate; diallyl maleate; diallyl itaconate; triallyl cyanurate; triallyl isocyanurate; diallyl terephthalate; triallyl trimesate; and the like,but not limited to these. These monomers may be used alone or by mixing two or more kinds.

The aforesaid copolymerizable monomer is a component used to adjust the polarity, Tg and refractive index of the rubbery polymer. Examples of the copolymerizable monomer are acrylic acid, methacrylic acid, styrene, α-methyl styrene, 1-vinylnaphthalene, 2-vinylnaphthalene, 1,3-butadiene, isoprene, chloroprene, vinyl acetate, acrylonitrile, methacrylonitrile, methyl acrylate, methyl methacrylate, ethyl methacrylate, 2-hydroxyethyl methacrylate, n-propyl methacrylate, 3-thiabutyl acrylate, 4-thiabutyl acrylate, 3-thiapentyl acrylate, N-stearyl acrylamide and the like, but not limited to these. These monomers may be used alone or by mixing two or more kinds.

The amount of the alkyl acrylate to be used is preferably 45 to 99.95% by weight, more preferably 70 to 99.8% by weight, based on 100% by weight of the total rubbery polymer contained in the core component, in order to demonstrate good impact resistance. When the amount of the alkyl acrylic ester is too small, problems such as an increase in the Tg of the rubbery polymer and a decrease in impact resistance arise. When the amount of the alkyl acrylic ester is too large, the crosslinked structure is lost, disabling the rubbery polymer to maintain a suitable particle size when molding.

The amount of the alkyl methacrylate to be used is preferably 0 to 40% by weight, more preferably 0 to 27% by weight based on 100% by weight of the total rubbery polymer contained in the core component. When the amount is too large, the impact resistance decreases because the modulus rises too much owing to an increase in the Tg of the rubbery polymer and a generation of a crystal area.

The amount of the multifunctional monomer to be used is preferably 0.05 to 5% by weight, more preferably 0.2 to 3% by weight based on 100% by weight of the total rubbery polymer contained in the core component, in order to obtain good impact resistance. When the amount of the multifunctional monomer is too small, the crosslinked structure is lost, disabling the rubbery polymer to maintain a suitable particle size when molding. When the amount of the multifunctional monomer is too large, the modulus rises too much.

Furthermore, the amount of the copolymerizable monomer to be used is preferably 0 to 10% by weight, more preferably 0% by weight based on 100% by weight of the total rubbery polymer contained in the core component, so that the impact resistance and weatherability of the molded article finally obtained are not damaged.

The most preferable embodiment of the rubbery polymer of the core is, from the viewpoint of providing a graft copolymer composition with good weatherability and impact resistance, and conducting production with ease, a polymer obtained by polymerizing among the aforesaid alkyl acrylate, particularly an alkyl acrylate, which has an alkyl group having 2 to 12 carbon atoms, and the multifunctional monomer.

In this case, the amount of alkyl acrylate to be used is preferably 95 to 99.9% by weight, more preferably 97 to 99.8% by weight based on 100% by weight of the total rubbery polymer contained in the core component, in order to especially demonstrate good impact resistance. When the amount of the alkyl acrylic ester is too small, problems such as an increase in the Tg of the rubbery polymer and a decrease in impact resistance arise. When the amount of the alkyl acrylic ester is too large, the crosslinked structure is lost, disabling the rubbery polymer to maintain a suitable particle size when molding.

The amount of the multifunctional monomer to be used is preferably 0.1 to 5% by weight, more preferably 0.2 to 3% by weight based on 100% by weight of the total rubbery polymer contained in the core component, in order to obtain good impact resistance. When the amount of the multifunctional monomer is too small, the crosslinked structure is lost, disabling the rubbery polymer to maintain a suitable particle size when molding. When the amount of the multifunctional monomer is too large, the modulus rises too much.

The glass transition temperature (Tg) of the polymer is found by data from “Polymer Handbook” (John Wiley & Sons) regarding homopolymers, and from the Fox formula using this data regarding copolymers.

The core of the core-shell polymer (A) used in the present invention, can be a rubbery polymer or a hard polymer. In order to demonstrate sufficient impact resistance, a rubbery polymer is preferable. In this case, at least 75% by weight of the rubbery polymer is preferably contained based on 100% by weight of the total core component.

In order to demonstrate good impact resistance, the upper limit of particle size of the core component of the core-shell polymer (A) used in the present invention is preferably at most 0.7 μm, more preferably at most 0.5 μm, most preferably at most 0.3 μm. The lower limit of particle size of the core component is preferably at least 0.03 μm, more preferably at least 0.05 μm, from the same reason. The particle size dispersion of the core component may be in a monodisperse, but may also be in a polydisperse with a particle size distribution of at least 2. When the particle size exceeds 0.7 μm or is below 0.03 μm, good impact resistance may not be obtained.

The method of obtaining the core component of the core-shell polymer (A) used in the present invention is not particularly limited but the usual polymerization methods such as emulsion polymerization, compulsory emulsion polymerization, bulk polymerization and solution polymerization may be employed. However, in order to easily obtain the suitable particle size mentioned above, preparation by emulsion polymerization or compulsory emulsion polymerization is preferable, and preparation by emulsion polymerization is more preferable.

When preparing the core component of the core-shell polymer (A) by emulsion polymerization, the emulsifier to be used is not particularly limited and the usual emulsifiers may be used. When adding the monomer or monomer mixture which provides the core component to the reactor, the methods of adding all at once or one portion or all continuously or intermittently may be employed. In this case, the method of adding the monomer or monomer mixture emulsified with an emulsifier and water in advance or the method of adding an emulsifier or aqueous solution of an emulsifier apart from the monomer or monomer mixture continuously or in segments may be employed.

When conducting polymerization of the monomer for the core component contained in the rubbery polymer of the core-shell polymer (A) of the present invention, the usual initiator is used. Examples of the initiator are peroxides such as potassium persulfate, benzoyl peroxide, t-butyl peroxide and cumeme hydroperoxide, and azobisisobutyronitrile, but not limited to these in the present invention. These initiators may also be used in combination. Furthermore, when the core component comprises a polymer of two or more layers, the same initiator may be used in each layer and a different initiator may be used as well. Besides these thermal decomposition type methods, a redox type initiator of using the aforesaid peroxide and a reducing agent and/or co-catalyst together may also be applied. As the reducing agent, sodium formaldehyde sulfoxyate, for example can be given but is not limited to this. The co-catalyst is a catalyst system which bears the role of transferring electrons to the peroxide from the reducing agent. A combination of ferrous sulfate and disodium ethylenediaminetetraacetate may be given as an example of the co-catalyst, but the co-catalyst is not limited to this.

The shell component of the core-shell polymer (A) used in the present invention has a particular range of molecular weight and due to this molecular weight range, the shell component is considered to have the function of advancing gelation of the vinyl chloride resin.

The shell component of the graft copolymer (A) used in the present invention is also considered to provide the function of adhering the core component of the graft copolymer (A) to the vinyl chloride resin matrix which are not compatible with each other. Therefore, the component is considered to have the function of dispersing the core component within the vinyl chloride resin matrix while keeping the designed particle size without coagulation when molding.

The core-shell polymer (A) used in the present invention is characterized by the polymerization degree of the shell component. The polymerization degree of the core-shell polymer (A) is evaluated by the specific viscosity found by measuring at 30° C. using a 0.2 g/100 ml acetone solution of a portion soluble in methyl ethyl ketone and insoluble in methanol. This portion soluble in methyl ethyl ketone and insoluble in methanol is obtained by dropping the extracted solution obtained from the core-shell polymer composition by extracting with methyl ethyl ketone to methanol 20 to 30 times in weight of the extracted solution with stirring and then collecting the precipitated solid. The specific viscosity found by measuring at 30° C. using a 0.2 g/100 ml acetone solution of a portion soluble in methyl ethyl ketone and insoluble in methanol of the core-shell polymer (A) used in the present invention is preferably at least 0.19, more preferably at least 0.2 in order to sufficiently advance the gelation of the vinyl chloride resin when molding. When the specific viscosity is less than 0.19, gelation does not sufficiently progress and impact resistance decreases. Furthermore, though the upper limit of the aforesaid η sp (specific viscosity) is not particularly set, the specific viscosity is preferably at most 1, more preferably at most 0.8, most preferably at most 0.65, in order to prevent problems such as deterioration of product appearance due to melt fracture, burning and a decrease in heat stability due to heat generation by shearing of the melted resin and deterioration of heat contraction from arising.

The core-shell polymer (A) of the present invention preferably contains at least 2% by weight, more preferably at least 3% by weight, most preferably at least 5% by weight of the portion soluble in methyl ethyl ketone and insoluble in methanol of the core-shell polymer composition, in order to favorably improve the gelation properties of the vinyl chloride resin.

One preferable embodiment of the shell component of the core-shell polymer (A) of the present invention is a polymerizing methyl methacrylate, at least one monomer or monomer mixture selected from the group consisting of alkyl acrylate, which has an alkyl group having 1 to 18 carbon atoms, alkyl methacrylate, which has an alkyl group having 2 to 18 carbon atoms, unsaturated nitrile and aromatic vinyl compound, and a monomer copolymerizable therewith.

Examples of the alkyl acrylate mentioned above are methyl acrylate, in addition to the examples given for the rubbery polymer contained in the core component of the core-shell polymer (A) of the present invention, but not limited to these. These monomers may be used alone or in a mixture of two or more kinds. Examples of the alkyl methacrylic ester mentioned above are, among monomers given for the rubbery polymer contained in the core component of the core-shell polymer (A) of the present invention, those having 2 to 18 carbon atoms and ethyl methacrylate, 2-hydroxyethyl methacrylate, n-propyl methacrylate and the like but not limited to these. These monomers may be used alone or in a mixture of two or more kinds. Examples of the unsaturated nitrile mentioned above are acrylonitrile, methacrylonitrile and the like but not limited to these. These monomers may be used alone or in a mixture of two or more kinds. Examples of the aromatic vinyl compound mentioned above are styrene, a-methyl styrene, 1-vinyl naphtalene, 2-vinyl naphtalene, and the like but not limited to these. These monomers may be used alone or in a mixture of two or more kinds. Examples of the copolymerizable polymer mentioned above are acrylic acid, methacrylic acid, vinyl acetate, 3-thiabutyl acrylate, 4-thiabutyl acrylate, 3-thiapentyl acrylate, N-stearyl acrylamide and the like but not limited to these. These monomers may be used alone or in a mixture of two or more kinds. The multifunctional monomer given as examples in the case of the rubbery polymer contained in the core component of core-shell polymer (A) may also be included as the copolymerizable monomer.

The amount to be used of methyl methacrylate contained in the shell component is preferably 40 to 100% by weight, more preferably 60 to 100% by weight based on 100% by weight of the total shell component, so that compatibility with the vinyl chloride resin matrix can be sufficiently maintained.

The amount to be used of at least one monomer or monomer mixture selected from the group consisting of alkyl acrylate, alkyl methacrylate, unsaturated nitrile and aromatic vinyl compound is preferably 0 to 60% by weight, more preferably 0 to 40% by weight based on 100% by weight of the total shell component, so that compatibility with the vinyl chloride resin matrix does not decrease.

The amount to be used of the copolymerizable monomer is preferably 0 to 10% by weight, more preferably 0% by weight based on 100% by weight of the total shell component, so that compatibility with the vinyl chloride resin matrix does not decrease.

Among the shell component, from the viewpoint of particularly excellent weatherability and facilitated preparation, a polymer comprising methyl methacrylate and at least one monomer or monomer mixture selected from the group consisting of alkyl acrylate, which has an alkyl group having 1 to 12 carbon atoms, and alkyl methacrylate, which has an alkyl group having 2 to 8 carbon atoms, is preferable.

In this case, the preferable amount of methyl methacrylate to be used is as described above. The amount to be used of at least one monomer or monomer mixture selected from the group consisting of alkyl acrylate, which has an alkyl group having 1 to 12 carbon atoms, and alkyl methacrylate, which has an alkyl group having 2 to 8 carbon atoms, is preferably 0 to 60% by weight, more preferably 0 to 40% by weight based on 100% by weight of the total shell component, so that compatibility with the vinyl chloride resin matrix does not decrease.

Another preferable embodiment of the shell component of the core-shell polymer (A) of the present invention is a polymer further comprising aromatic vinyl compound, unsaturated nitrile and a monomer copolymerizable therewith.

Examples of the above aromatic vinyl compound, unsaturated nitrile and copolymerizable monomer are the same as those given for the polymer comprising methyl methacrylate, at least one monomer or monomer mixture selected from the group consisting of alkyl acrylate, which has an alkyl group having 1 to 18 carbon atoms, alkyl methacrylate, which has an alkyl group having 2 to 18 carbon atoms, unsaturated nitrile and aromatic vinyl compound, and a monomer copolymerizable therewith.

The amount to be used of the aromatic vinyl compound and unsaturated nitrile is preferably 50 to 90% by weight of aromatic vinyl compound and 10 to 50% by weight of unsaturated nitrile, more preferably 70 to 88% by weight of aromatic vinyl compound and 12 to 30% by weight of unsaturated nitrile, based on 100% by weight of the total shell component, in order to sufficiently maintain compatibility with the vinyl chloride resin matrix. The amount to be used of the copolymerizable monomer is preferably 0 to 10% by weight, more preferably 0% by weight based on 100% by weight of the total shell component, so that weatherability and compatibility with the vinyl chloride resin matrix do not decrease.

The shell of the core-shell polymer (A) used in the present invention comprises at least one polymer layer and may also comprise at least two polymer layers. When the shell comprises at least two polymer layers, there may be layers of the same composition or different composition. When each layer has a different composition, the layers may be in the form of overlapping layers, in the from of layers with continuous composition difference, or in the form of one dispersed in the continuous layer of the other, or a combination of these, as the form is not particularly limited. Furthermore, the rubbery polymer may have a shell.

The method for polymerization of the shell component of the core-shell polymer (A) of the present invention is not limited but the most preferable method is emulsion polymerization. That is, the shell component is prepared by polymerizing at least one monomer or monomer mixture for the shell component in one step or more in the presence of the core component which is in a latex state. When conducting polymerization, the monomer component for the shell component may be added to the reactor for example all at once, or one portion or all may be added continuously or intermittently to polymerize. Furthermore in order to raise the polymerization degree (specific viscosity), one portion or all of the monomer component may be added at once with a small amount of catalyst to polymerize. The monomer component may be used after mixing all, or polymerization may be conducted in two steps or multiple steps of at least two steps with adjusting each layer to a different composition within the range of the composition of the monomer component.

The initiators used for polymerization are the same as those used for the polymerization of the core component. These may be the same or different for the core component and the shell component. Furthermore, at least two kinds of initiators may be used in combination. As for the initiators used when preparing the polymers of each layer of the shell component comprising at least two polymer layers, the initiators are the same as those used when preparing the core component comprising at least two polymer layers.

When preparing the core-shell polymer (A) by emulsion polymerization, besides using the usual unenhanced core components, particle size enhancement may be conducted as well. When conducting particle size enhancement, the method of carrying out the enhancement when the core component is in a latex state or during graft polymerization may be employed. The usual particle size enhancement is a method of using salt, acid or a polyelectrolyte such as latex containing acid group, but is not limited to these.

In the core-shell polymer (A) used in the present invention obtained in this way, the amount of the core component is preferably at least 25% by weight, more preferably at least 35% by weight, most preferably at least 45% by weight, based on 100% by weight of the total amount of the core component and shell component, in order to sufficiently demonstrate impact resistance. In addition, the amount of the core component is preferably at most 95% by weight, more preferably at most 93% by weight, based on 100% by weight of the total amount of the core component and shell component, in order to ensure sufficient dispersion of the particles of the core-shell copolymer (A) within the molded article. Corresponding with this, the amount of the shell component contained in the core-shell polymer (A) is preferably at least 5% by weight, more preferably at least 7% by weight, and preferably at most 75% by weight, more preferably at most 65% by weight, most preferably at most 55% by weight, based on 100% by weight of the total amount of the core component and shell component, all owing to the same reasons as above.

The acid or anionic surfactant (B) used in the present invention is considered to be a component having the effect of decreasing friction between the melted vinyl chloride resin and the metal surface of the molding machine and/or decreasing intermolecular friction within the melted resin, as mentioned before.

The acid or anionic surfactant (B) used in the present invention is selected from the group consisting of alkyl sulfates, salts of alkyl sulfofatty acid ester, alkyl sulfonates, alkyl phosphates or salts thereof and alkyl phosphites or salts thereof. Examples of the acid or anionic surfactant (B) are alkyl sulfate salt such as sodium lauryl sulfate and sodium stearyl sulfate; alkyl amide sulfates such as sodium lauryl amide sulfate; alkyl sulfates such as polyoxyalkylene alkyl sulfate, polyoxyalkylene alkyl phenyl ether sulfate and alkyl ether sulfate; dialkyl sulfosuccinate such as sodium di(n-octyl)sulfosuccinate; salt of alkyl sulfofatty acid such as monoalkyl sulfosuccinate; alkyl sulfonate such as sodium lauryl sulfonate; alkyl benzene sulfonate such as sodium lauryl benzene sulfonate; alkyl naphthalene sulfonate such as sodium lauryl naphthalene sulfonate; alkyl sulfonate such as alkyl aryl sulfonate, alkyl amide sulfonate, alkyl ether sulfonate, alkyl diphenyl ether disulfonate and monovalent acylmethyl taurine sulfonate; alkyl phosphate or a salt thereof represented by the formula O═P(OR)₂(OM) (in which R represents an alkyl group and M represents H, metal ion or ammonium) or a formula O═P(OR)(OM)₂ (in which R and M are as defined above), such as acidic monoalkylphosphate, acidic dialkyl phosphate or a salt thereof, acidic monoalkylpolyoxyalkylene phosphate, acidic dialkylpolyoxyalkylene phosphate or a salt thereof, and acidic monoalkylarylpolyoxyalkylene phosphate, acidic dialkylarylpolyoxyalkylene phosphate or a salt thereof; alkyl phosphite or a salt thereof represented by the formula O═P(OR)(OM) (in which R and M are as defined above), such as acidic alkyl phosphite or a salt thereof and acidic alkyl polyoxyethylene phosphite or a salt thereof. Examples of the salt are lithium salt, sodium salt, potassium salt, ammonium salt, triethyl ammonium salt, triethanol amine salt, magnesium salt and calcium salt. These acids or anionic surfactants (B) may be used alone or in a combination of two or more.

As the acid or anionic surfactant (B) used in the present invention, those in which alkyl group is a saturated or unsaturated hydrocarbon group having 8 to 20 carbon atoms is preferable, as a particularly excellent improvement effect of mold processability can be obtained.

An especially preferable embodiment of the acid or anionic surfactant (B) is a salt of higher alcohol sulfate such as sodium lauryl sulfate. Other particularly preferable embodiments are a salt of dialkylsulfosuccinic acid such as sodium dioctylsulfosuccinate; acidic alkylpolyoxyalkylene phosphite such as acidic dipalmitilpolyoxyethylene phosphite and acidic dioctylphenylpolyoxyethylene phosphite; and a salt of alkylpolyoxyalkylene phosphite such as sodium lauryl polyoxyethylene sulfate. These acids or anionic surfactants are preferable, as a high improvement effect of mold processability can be obtained even if they are used in a small amount.

There are no particular limitations to the salt of the acid or anionic surfactant (B), but alkali metal salt such as lithium salt, sodium salt and potassium salt, or ammonium salt such as ammonium salt, triethyl ammonium salt and triethanol ammonium salt are preferable, as a high improvement effect of mold processability can be obtained even if they are used in a small amount.

In this way, the core-shell polymer composition of the present invention is defined by containing the core-shell polymer (A) and at least one kind of acid or anionic surfactant (B), as mentioned before.

The proportion of the core-shell polymer (A) and the acid or anionic surfactant (B) contained within the core-shell polymer composition of the present invention is 85 to 99.4% by weight of the core-shell polymer (A) and 15 to 0.6% by weight of the acid or anionic surfactant (B), preferably 88 to 99% by weight of the core-shell polymer (A) and 12 to 1% by weight of the acid or anionic surfactant (B), based on 100% by weight of the total amount of the core-shell polymer (A) and the acid or anionic surfactant (B). More preferably, the proportion is 90 to 97.7% by weight of the core-shell polymer (A) and 10 to 2.3% by weight of the acid or anionic surfactant (B), most preferably 91.5 to 97.2% by weight of the core-shell polymer (A) and 8.5 to 2.8% by weight of the acid or anionic surfactant (B), based on 100% by weight of the total amount of the core-shell polymer (A) and the acid or anionic surfactant (B). When the proportion of core-shell polymer (A) is less than 85% by weight (the proportion of acid or anionic surfactant (B) exceeds 15% by weight), the gel properties when molding decrease, a sufficient improvement effect in the impact resistance of the final molded article cannot be obtained and problems such as plate-out may occur. When the proportion of core-shell polymer (A) exceeds 99.4% by weight (the proportion of acid or anionic surfactant (B) is less than 0.6% by weight), burning may develop from an increase in heat generation by shearing of the resin when molding and a decrease in heat stability may be brought about. In addition, the load on the molding machine may significantly increase and as a result, productivity may be decreased.

As a preferable method of preparing the core-shell polymer composition of the present invention, there is the method of using a suitably selected acid or anionic surfactant (B) as the emulsifier when synthesizing the core-shell polymer (A) by emulsion polymerization. There is also the method of adding a suitably selected acid or anionic surfactant (B) afterwards to the core-shell polymer (A) in a latex state. In either of these methods, the latex of the core-shell polymer (A) can be spray dried, or collected as dry powder, having gone through heating, dehydration and drying, after coagulation by electrolytes such as calcium chloride, magnesium chloride, calcium sulfate, magnesium sulfate, aluminum sulfate, calcium acetate and calcium formate, polyelectrolytes, or acids such as sulfuric acid, hydrochloric acid, acetic acid, phosphoric acid, nitric acid and tartaric acid. When heating is carried out, the slurry is preferably cooled to at most 25° C., more preferably at most 18° C., most preferably at most 10° C. after heating and followed by dehydration. Thereby, the added acid or anionic surfactant (B) can be kept within or in the vicinity of the resin of the core-shell polymer (A) without flowing out. As a result, the various factors of processing when preparing the molded article of the vinyl chloride resin composition of the present invention by extrusion molding, such as the load to the molding machine, productivity, that is throughput, and long running, are improved. The composition can also be collected in the form of pellet by processing the dry powder of the obtained core-shell polymer composition using an extruder or Banbury mixer. Alternatively, the powder containing water obtained by coagulation, heating and dehydration can be collected as a pellet by putting through a compression dehydrator. In this case, owing to the aforesaid reasons, cooling the slurry after heating is preferable.

Another preferable method for preparing the core-shell polymer composition of the present invention is the method of adding a suitably selected acid or anionic surfactant (B) to the core-shell polymer (A) slurry after coagulation, after coagulation and heating, or after coagulation, heating and cooling. The method of adding while heating is also possible. In these methods, the composition can be collected as dry powder by carrying out further heating according to need, and then preferably through cooling, dehydrating and drying in the above manner from the same reasons. The composition can also be collected as a pellet according to the method of using an extruder, Banbury mixer or compression dehydrator as above.

Another preferable method for preparing the core-shell polymer composition of the present invention is the method of adding a suitably selected acid or anionic surfactant (B) to the core-shell polymer (A) after dehydration. In this method, the composition can be collected as dry powder after drying, or as a pellet according to the method of using an extruder, Banbury mixer or compression dehydrator as above.

In each of these methods, the form of the acid or anionic surfactant (B) to be added is not limited and may be in any of the forms of a solid, liquid or solution.

Another preferable method for preparing the core-shell polymer composition of the present invention is the method which comprises adding a desired amount of a suitably selected acid or anionic surfactant (B) in a solid state to the core-shell polymer (A) made into powder or pellets in advance or adding the acid or anionic surfactant (B) in a liquid or solution state, being absorbed into the core-shell polymer (A), and then drying according to need. The powder or pellets of the core-shell polymer composition obtained by these methods can be collected as pellets by pelletizing after kneading with an extruder, Banbury mixer and the like.

To the core-shell polymer composition of the present invention, stabilizers such as antioxidant and ultraviolet ray absorbing agent and modifiers for powder property such as silicon oil and a crosslinked methyl methacrylate polymer may be added, within the range of the proportion of the core-shell polymer (A) and acid or anionic surfactant (B).

The core-shell polymer composition of the present invention obtained in this way can be used as a vinyl chloride resin composition by compounding with vinyl chloride resin (C). To the vinyl chloride resin composition of the present invention, fillers such as calcium carbonate and titanium oxide, lubricants such as polyethylene wax and calcium stearate, high molecular weight processing aids or high molecular weight lubricants having methyl methacrylate as the main component, tin stabilizers such as methyl tin mercaptide, butyl tin mercaptide and octyl tin mercaptide, lead stabilizers such as lead stearate and dibasic lead phosphate, stabilizers such as calcium/zinc stabilizer and cadmium/barium stabilizer, and pigment such as carbon black may be added.

The method of preparing the vinyl chloride resin composition of the present invention is not particularly limited. It is possible to conduct the method of mixing the core-shell polymer composition of the present invention mentioned above with a vinyl chloride resin (C) and another compounding agent according to need; the method of mixing the core-shell polymer (A), the acid or anionic surfactant (B) of the present invention, a vinyl chloride resin (C), and another compounding agent according to need at once; the method of mixing the core-shell polymer (A), a vinyl chloride resin (C) and another compounding agent according to need in advance, and then adding the acid or anionic surfactant (B) and another compounding agent according to need; the method of mixing the acid or anionic surfactant (B), a vinyl chloride resin (C) and another compounding agent according to need in advance, and then adding the core-shell polymer (A) and another compounding agent according to need.

No matter which method is used to prepare, the vinyl chloride resin composition of the present invention contains the core-shell polymer (A) and the acid or anionic surfactant (B) in the same proportion given for the core-shell polymer composition of the present invention. Furthermore, in order to prevent deformation such as flexure while properly demonstrating the impact resistance and maintaining suitable rigidity of the final molded article, the vinyl chloride resin composition of the present invention contains 1 to 30 parts by weight, preferably 1.2 to 25 parts by weight, more preferably 1.5 to 20 parts by weight of the aforesaid core-shell polymer composition based on 100 parts by weight of the vinyl chloride resin (C).

The vinyl chloride resin (C) used in the present invention is not particularly limited, and may be a vinyl chloride homopolymer, a resin comprising a copolymer of a vinyl chloride monomer and another monomer copolymerizable with the vinyl chloride monomer, or a blend of resin comprising vinyl chloride resin and another polymer. The vinyl chloride resin (C) contains at least 70% by weight of a polymer unit derived from vinyl chloride monomer based on the total polymer units. Furthermore, the average polymerization degree of the vinyl chloride resin is not particularly limited, but is preferably approximately 300 to 1,700, in consideration of the easiness of processing when molding.

The vinyl chloride resin obtained in this way is excellent in weatherability and has not only extremely good impact resistance, but also excellent processability in extrusion molding. That is, processing can be conducted while advancing the kneading to a sufficient degree with a smaller load on the molding machine, and thus dimensional stability is excellent. Furthermore, because the melt viscosity can be maintained properly during molding, defective appearance due to melt fracture does not occur. In addition, problems such as burning and a decrease in heat stability do not arise, as heat generation by the shearing of the melted resin is small and molding can be done at a low temperature. The vinyl chloride resin composition of the present invention can be used as a pellet compound by putting through an extruder, Banbury mixer and the like, and as the heat generation by the shearing when pelletizing is small, the heat stability of the obtained pellets is good. Also, because the heat history of the pellet is small, the pellets collapse and can be processed well when transformed into the final molded article, and superior surface appearance can be provided.

The molded article of the vinyl chloride resin composition of the present invention is superior in weatherability and impact resistance, is not colored by burning of the resin and is free from faulty appearance or dimensional strain. Therefore, the products of the present invention which include the aforesaid molded article, have good mechanical strength and appearance. Herein, the products include articles which are made solely of the aforesaid molded article. The method for obtaining the molded article is not particularly limited, but the usual extrusion molding or injection molding or the like may be used. The vinyl chloride resin composition of the present invention may be provided as pipes, window frames, fences, door, switchboxes or parts constructing these. Furthermore, the composition may also be provided as a pellet for mold processing material.

Hereinafter the present invention is explained in detail based on Examples, but not limited thereto. The abbreviations used in Examples, Comparative Examples and Tables are as defined below.

BA: butyl acrylate

MMA: methyl methacrylate

BMA: butyl methacrylate

St: styrene

nOA: n-octyl acrylate

2EHA: 2-ethyl hexyl acrylate

SMA: stearyl methacrylate

SA: stearyl acrylate

LMA: laruryl methacrylate

LA: lauryl acrylate

Ca: calcium

Zn: zinc

Pb: lead

Also Lx in Tables represents latex.

When powdery graft copolymer is prepared through coagulation, the acid or anionic surfactant (B) in Tables is regarded to be totally converted to metal salt (e.g. calcium salt).

In Tables, the ratio (A)/(B) of the graft copolymer (A) to the acid or anionic surfactant (B) is represented by a value obtained by calculation from the total amount of those used during polymerization, added to the latex after polymerization, mixed in the form of powder and added simultaneously in blending.

### EXAMPLE 1

A pressure polymerization reactor equipped with a stirrer was charged with 225 parts (parts by weight in the followings as well) of distilled water, 0.3 part of sodium oleate, 0.002 part of ferrous sulfate (FeSO₄.7H₂O), 0.005 part of disodium ethylenediaminetetraacetate (hereinafter EDTA), 0.2 part of sodium formaldehyde sulfoxylate and 0.1 part of sodium carbonate, and the temperature was elevated to 58° C. The air inside the reactor was then replaced with nitrogen, and the pressure was reduced. Thereto was added 10% by weight of a mixed solution containing 99.4 parts of butyl acrylate, 0.6 part of allyl methacrylate and 0.2 part of cumene hydroperoxide all at once. After one hour, 10 parts of distilled water and 0.08 part (solid content) of 5% sodium oleate aqueous solution were added, and immediately thereafter, the remaining 90% by weight of the mixed solution was continuously added over 5 hours. At 1.5 hours and 3 hours from the start of the polymerization, 0.24 part (solid content) of 5% sodium oleate aqueous solution was added. Immediately after the completion of the continuous addition, 0.05 part of cumene hydroperoxide was added, and one hour of post-polymerization was further conducted. The polymerization conversion was 99%. An acrylic rubber latex (R-1) with an average particle size of 0.12 μm, containing a rubbery polymer having a glass transition temperature of −41° C. was obtained.

A pressure polymerization reactor equipped with a stirrer was charged with 181 parts of distilled water, 0.002 part of ferrous sulfate (FeSO₄.7H₂O), 0.005 part of disodium EDTA, and 0.1 part of sodium formaldehyde sulfoxylate. Subsequently, 65 parts of the acrylic rubber latex (R-1) in solid content was added thereto, and the temperature was elevated to 56° C. The air inside the reactor was then replaced with nitrogen, and the pressure was reduced. Thereto was continuously added a mixed solution of 32 parts of methyl methacrylate, 3 parts of butyl acrylate and 0.006 part of cumene hydroperoxide over 1.5 hours. Immediately after the completion of the continues addition, 0.05 part of cumene hydroperoxide was added and an hour of post-polymerization was further conducted. The polymerization conversion was 99%. A core-shell polymer latex (G-1) having an average particle size of 0.14 μm was obtained. The glass transition temperature of the rubbery polymer of the shell was 78° C.

The obtained core-shell polymer latex (G-1) was coagulated with calcium chloride, heat-treated, cooled to 10° C., and subjected to dehydration and drying to prepare powdery core-shell polymer (A-1).

The core-shell copolymer (A-1) and sodium lauryl sulfate were mixed in a weight ratio of 97/3 by using a blender and a core-shell polymer composition (M-1) was obtained.

The specific viscosity of the portion extracted from the core-shell polymer composition (M-1) was measured according to the following method:

(Specific viscosity)

After immersing the core-shell polymer composition (M-1) in methyl ethyl ketone for 48 hours, the soluble portion was separated by centrifugal separation and dropped into methanol to re-precipitate. The precipitated solid substance was collected, dried and made into a 0.2 g/100 ml acetone solution to measure the specific viscosity (ηₛₚ) at 30° C.

The measured specific viscosity is shown in Table 1 together with the characteristics of the core-shell polymer composition (M-1).

The ratio (α) of the precipitated substance to 100% by weight of the core-shell polymer is also shown in Table 1.

Subsequently 6 parts by weight of the core-shell polymer composition (M-1) was blended with 1.5 parts of dioctyl tin mercaptide (stabilizer, available from Katsuta Kako Co., Ltd., product name: TM-188J), 1.4 parts of calcium stearate (lubricant, available from Sakai Chemical Industry Co., Ltd., product name: SC-100), 1.5 parts of paraffin wax (lubricant, available from Nihon Seiro Co., Ltd., product name: HNP-10), 8 parts of titanium oxide (pigment: available from Sakai Chemical Industry Co., Ltd., product name: TI TONE R650), 4.5 parts of calcium carbonate (filler, available from OMYA Co., Ltd., product name: OMYACARB UFT), 1.8 parts of processing aid (available from Kaneka Corporation, product name: PA-20) and 100 parts of vinyl chloride (available from Kaneka Corporation, product name: S-1001, polymerization degree: 1,000). After that the mixture was extruded under the following molding conditions and formed into a board 2 mm in thickness.

(Molding Condition)

Molding machine: Conical Molding Machine TEC-55DV made by Toshiba Machine Co., Ltd., 2 mm slit die

Molding temperature: C1/C2/C3/C4/AD/D1/D2: 175/175/175/167/172/186/186 (° C.)

Rotation number of screw: 26 rpm

The extrusion load and throughput in molding are shown in Table 1.

Then by using the obtained board, the Gardner strength and Izod impact strength were evaluated according to the following method. (Gardner strength) In accordance with ASTM D4726-97 and D4226-95, Gardner strength at 23° C. was measured.

(Izod impact strength)

The boards were laminated and heat-pressed (at 195° C for 15 minutes) to prepare a sample 70 mm in length, 15 mm in width and 4 mm in thickness. Izod impact strength at 23° C. was measured in accordance with JIS K 7110.

The obtained Gardner strength values and Izod impact strength values are shown in Table 1.

By using the same compound as that used in the extrusion molding, the plasticization test was carried out under the following test conditions.

(Plasiticization Test)

Machine: Labo Plastomill Model 20C200 made by Toyo Seiki Co., Ltd., Chamber

Rotation number of rotor: 30 rpm

Testing temperature: 170° C.

Amount to be filled: 70 g

Testing time: 40 minutes

The results of estimating the equilibrium torque value and resin temperature at which the equilibrium torque is reached, according to the time-torque curve obtained in the test, are shown in Table 1.

### EXAMPLE 2

Evaluation was carried out in the same manner as in Example 1 except that a powdery graft copolymer (A-2) was obtained by adding 2.88 parts of sodium lauryl sulfate simultaneously with 0.002 part of ferrous sulfate (FeSO₄.7H₂O), 0.005 part of disodium EDTA and 0.1 part of sodium formaldehyde sulfoxylate in preparing the core-shell polymer latex (G-1), and that the core-shell polymer (A-2) alone was used as a core-shell polymer composition (M-1) without adding sodium lauryl sulfate. The results are shown in Table 1.

### EXAMPLE 3

Evaluation was carried out in the same manner as in Example 1 except that a powdery graft copolymer (A-3) was obtained by adding 4.17 parts of sodium lauryl sulfate immediately after the completion of the polymerization of the core-shell polymer latex (G-1), and that the core-shell polymer (A-3) alone was used as a core-shell copolymer composition (M-1) without adding sodium lauryl sulfate. The results are shown in Table 1.

### EXAMPLE 4

Evaluation was carried out in the same manner as in Example 1 except that a powdery core-shell polymer (A-4) was obtained by adding 4.17 parts of sodium lauryl sulfate immediately after the completion of the polymerization of the core-shell polymer latex (G-1), subjecting the latex to spray drying with an inlet temperature of 140° C. and an outlet temperature of 60° C., instead of coagulation with calcium chloride, heat treatment, cooling to 10° C., dehydration and drying; and that the core-shell polymer (A-4) alone was used as a core-shell copolymer composition (M-1) without adding sodium lauryl sulfate. The results are shown in Table 1.

### EXAMPLE 5

Evaluation was carried out in the same manner as in Example 1 except that in blending the core-shell polymer composition (M-1) with vinyl chloride and other compounding agents, instead of the core-shell polymer composition (M-1), the core-shell polymer (A-1) and a surfactant represented by the formula RO(CH₂CH₂O)₄—P(═O)(OH)₂ (in which R═C₁₈H₃₇) were blended, the ratio of the core-shell polymer (A-1) to the surfactant being 94/6. The results are shown in Table 1.

### EXAMPLE 6

Evaluation was carried out in the same manner as in Example 1 except that in blending the core-shell polymer composition (M-1) with vinyl chloride and other compounding agents, instead of the core-shell polymer composition (M-1), the core-shell polymer (A-1) and a surfactant represented by the formula [RO(CH₂CH₂O)₄]₂—P(═O)OH (in which R═C₁₈H₂₁) were blended, the ratio of the core-shell polymer (A-1) to the surfactant being 94/6. The results are shown in Table 1.

### EXAMPLE 7

Evaluation was carried out in the same manner as in Example 1 except that in blending the core-shell polymer composition (M-1) with vinyl chloride and other compounding agents, instead of the core-shell polymer composition (M-1), the core-shell copolymer (A-1) and a surfactant represented by the formula RO(CH₂CH₂O)₄—P(═O)(OH)₂ (in which R═C₁₂H₂₅(C₆H₄)) were blended, the ratio of the core-shell polymer (A-1) to the surfactant being 94/6. The results are shown in Table 1.

### EXAMPLE 8

Evaluation was carried out in the same manner as in Example 1 except that in blending the core-shell polymer composition (M-1) with vinyl chloride and other compounding agents, instead of the core-shell polymer composition (M-1), the core-shell polymer (A-1) and sodium dioctylsulfosuccinate were blended, the ratio of the core-shell polymer (A-1) to the surfactant being 94/6. The results are shown in Table 1.

### COMPARATIVE EXAMPLE 1

Evaluation was carried out in the same manner as in Example 1 except that the core-shell polymer (A-1) alone was used as a core-shell polymer composition (M- 1) without adding sodium lauryl sulfate. The results are shown in Table 1.

### COMPARATIVE EXAMPLE 2

Evaluation was carried out in the same manner as in Example 1 except that a mixture of the core-shell polymer (A-1) and sodium lauryl sulfate in a ratio of 99.9/0.1 was used instead of the core-shell polymer composition (M-1). The results are shown in Table 1.

### COMPARATIVE EXAMPLE 3

Evaluation was carried out in the same manner as in Example 1 except that a mixture of the core-shell polymer (A-1) and sodium lauryl sulfate in a ratio of 80/20 was used instead of the core-shell polymer composition (M-1). The results are shown in Table 1. When this core-shell polymer composition was evaluated, melting was not observed in the plasticization test, which means that the melting time, equilibrium torque value and resin temperature at which the equilibrium torque is reached were not found.

### COMPARATIVE EXAMPLE 4

As to the mixture used for preparing the core-shell polymer latex (G-1) of Example 1, the amount of cumene hydroperoxide was changed to 1 part from 0.006 part, and a core-shell polymer latex (G-2) was obtained from this mixture. Evaluation was carried out in the same manner as in Example 4 except that the core-shell polymer latex (G-2) was used instead of the core-shell polymer latex (G-1). The results are shown in Table 1.

### COMPARATIVE EXAMPLE 5

As to the mixture used for preparing the acrylic rubber latex (R-1) of Example 1, a mixed solution containing 59 parts of butyl acrylate, 40.4 parts of styrene, 0.6 part of allyl methacrylate and 0.8 part of cumene hydroperoxide was used instead of a mixed solution containing 99 parts of butyl acrylate, 0.6 part of allyl methacrylate and 0.2 part of cumene hydroperoxide, and an acrylic-styrene rubber latex (R-2) having a glass transition temperature of 4° C. was obtained. Using this acrylic-styrene rubber latex (R-2) instead of acrylic rubber latex (R-1), a graft copolymer latex (G-3) was obtained as in Example 1. Evaluation was carried out in the same manner as in Example 4 except that the graft copolymer latex (G-3) was used instead of the core-shell polymer latex (G-1). The results are shown in Table 1.

### EXAMPLE 9

A pressure polymerization reactor equipped with a stirrer was charged with 175 parts of distilled water, 0.123 part of sodium lauryl sulfate, 0.0015 part of ferrous sulfate (FeSO₄.7H₂O), 0.006 part of disodium EDTA and 0.2 part of sodium formaldehyde sulfoxylate, and the temperature was elevated to 58° C. The air inside the reactor was then replaced with nitrogen, and the pressure was reduced. Thereto was added 10% by weight of a monomer mixture of 99.6 parts of butyl acrylate, 0.4 part of allyl methacrylate and 0.15 part of cumene hydroperoxide all at once. After 1 hour, 15 parts of distilled water, 0.18 part (solid content) of 5% sodium lauryl sulfate aqueous solution and 0.1 part (solid content) of 5% sodium carbonate aqueous solution were added, and immediately thereafter, the remaining 90% by weight of the monomer solution was continuously added over 6 hours. At 2 hours and 4 hours from the start of the polymerization, 0.2 part (solid content) of 5% sodium lauryl sulfate aqueous solution was added. 30 minutes after the completion of the continuous addition of the monomer mixture, 0.01 part of cumene hydroperoxide was added and after raising the temperature to 70° C., 1 hour of post-polymerization was further conducted. An acrylic rubber latex (R-3) with an average particle size of 0.13 μm, containing a rubbery polymer having a glass transition temperature of −41° C. was obtained.

A pressure polymerization reactor equipped with a stirrer was charged with 100 parts of distilled water, 0.2 part of sodium lauryl sulfate, and 0.1 part of sodium formaldehyde sulfoxylate. Subsequently, 70 parts of the acrylic rubber latex (R-3) in solid content was added thereto, and the temperature was elevated to 56° C. The air inside the reactor was then replaced with nitrogen, and the pressure was reduced. Thereto was continuously added a mixed solution of 25 parts of methyl methacrylate, 5 parts of butyl methacrylate and 0.006 part of cumene hydroperoxide all at once. 2 hours later, 0.01 part of cumene hydroperoxide was added and 1 hour of post-polymerization was further conducted. A core-shell polymer latex (G-4) having an average particle size of 0.15 μm was obtained. The glass transition temperature of the rubbery polymer of the shell was 83° C.

The obtained core-shell polymer latex (G-4) was coagulated with calcium chloride, after adding 2.6 parts of sodium lauryl sulfate, then heat-treated, cooled to 10° C., and subjected to dehydration and drying to prepare powdery graft copolymer (A-5).

Below, evaluation was carried out in the same manner as in Example 1 except that the obtained core-shell polymer (A-5) was used instead of the core-shell polymer composition (M-1), blended together with vinyl chloride and other compounding agents in an amount of 5.8 parts. The results are shown in Table 2.

### EXAMPLE 10

The core-shell polymer latex (G-4) of Example 9 was coagulated with calcium chloride, without adding sodium lauryl sulfate, then heat-treated, cooled to 10° C., and subjected to dehydration and drying to prepare powdery core-shell polymer (A-6). Evaluation was carried out in the same manner as in Example 1 except that the obtained core-shell polymer (A-6) was used instead of the core-shell polymer composition (M-1), blended together with vinyl chloride and other compounding agents in an amount of 5.8 parts. The results are shown in Table 2.

### EXAMPLE 11

The core-shell polymer composition (M-2) was obtained by mixing the powdery core-shell polymer (A-6) of Example 10 with sodium lauryl sulfate in a weight ratio of 97.4/2.6. Evaluation was carried out in the same manner as in Example 1 except that the core-shell polymer composition (M-2) was used instead of the core-shell polymer composition (M-1), blended together with vinyl chloride and other compounding agents in an amount of 5.8 parts. The results are shown in Table 2.

### EXAMPLE 12

The specific viscosity was measured in the same manner as in Example 1 by using the powdery core-shell polymer (A-6) of Example 10 instead of the core-shell polymer composition (M-1). Evaluation was carried out in the same manner as in Example 1 except that 5.65 parts of powdery core-shell polymer (A-6) and 0.15 part of sodium lauryl sulfate were used instead of the core-shell polymer composition (M-1), blended together with vinyl chloride and other compounding agents. The results are shown in Table 2.

### EXAMPLE 13

After adding 2.6 parts of sodium lauryl sulfate to the core-shell polymer latex (G-4) of Example 9, the latex was subjected to spray drying with an inlet temperature of 140° C. and an outlet temperature of 60° C., instead of coagulation, to prepare powdery core-shell polymer (A-7). Evaluation was carried out in the same manner as in Example 1 except that this core-shell polymer (A-7) was used instead of the core-shell polymer composition (M-1), blended together with vinyl chloride and other compounding agents in an amount of 5.8 parts. The results are shown in Table 2.

### COMPARATIVE EXAMPLE 6

By repeating the procedure of dispersing the core-shell polymer (A-5) of Example 9 in 30 times in weight of methanol, stirring and then washing by suction filtration 4 times, the anionic surfactant was removed. After drying, the washed core-shell polymer composition (M-3) was obtained. Evaluation was carried out in the same manner as in Example 1 except that this core-shell polymer composition (M-3) was used instead of the core-shell polymer composition (M-1), blended together with vinyl chloride and other compounding agents in an amount of 5.8 parts. The results are shown in Table 2.

### EXAMPLE 14

A pressure polymerization reactor equipped with a stirrer was charged with 175 parts of distilled water, 0.123 part of sodium lauryl sulfate, 0.0015 part of ferrous sulfate (FeSO₄.7H₂O), 0.006 part of disodium EDTA and 0.2 part of sodium formaldehyde sulfoxylate, and the temperature was elevated to 58° C. The air inside the reactor was then replaced with nitrogen, and the pressure was reduced. Thereto was added 10% by weight of a mixed solution containing 99.6 parts of butyl acrylate, 0.4 part of allyl methacrylate and 0.15 part of cumene hydroperoxide all at once. After 1 hour, 15 parts of distilled water, 0.18 part (solid content) of 5% potassium palmitate aqueous solution and 0.1 part (solid content) of 5% sodium carbonate aqueous solution were added, and immediately thereafter, the remaining 90% by weight of the mixed solution was continuously added over 6 hours. At 2 hours and 4 hours from the start of the polymerization, 0.2 part (solid content) of 5% potassium palmitate aqueous solution was added. 30 minutes after the completion of the continuous addition, 0.01 part of cumene hydroperoxide was added and after raising the temperature to 70° C., 1 hour of post-polymerization was further conducted. An acrylic rubber latex (R-4) with an average particle size of 0.13 μm, containing a rubbery polymer having a glass transition temperature of −41° C. was obtained.

A pressure polymerization reactor equipped with a stirrer was charged with 100 parts of distilled water, 0.2 part of potassium palmitate, and 0.1 part of sodium formaldehyde sulfoxylate. Subsequently, 70 parts of the acrylic rubber latex (R-4) in solid content was added thereto, and the temperature was elevated to 56° C. The air inside the reactor was then replaced with nitrogen, and the pressure was reduced. Thereto was continuously added a mixed solution of 25 parts of methyl methacrylate, 5 parts of butyl methacrylate and 0.006 part of cumene hydroperoxide all at once. 2 hours later, 0.01 part of cumene hydroperoxide was added and 1 hour of post-polymerization was further conducted. A core-shell polymer latex (G-5) having an average particle size of 0.16 μm was obtained. The glass transition temperature of the rubbery polymer of the shell was 83° C.

The obtained core-shell polymer latex (G-5) was coagulated with calcium chloride after adding 3 parts of sodium lauryl sulfate, then heat-treated, cooled to 10° C., and subjected to dehydration and drying to prepare powdery core-shell polymer (A-8).

Below, evaluation was carried out in the same manner as in Example 1 except that the obtained core-shell polymer (A-8) was used instead of the core-shell polymer composition (M-1), blended together with vinyl chloride and other compounding agents in an amount of 5.8 parts. The results are shown in Table 3.

### EXAMPLE 15

The core-shell polymer latex (G-5) of Example 14 was coagulated with calcium chloride, without adding sodium lauryl sulfate, then heat-treated, cooled to 10° C., and subjected to dehydration and drying to prepare powdery core-shell polymer (A-9). The core-shell polymer composition (M-4) was obtained by mixing this core-shell polymer (A-9) with sodium lauryl sulfate in a weight ratio of 97.1/2.9. Evaluation was carried out in the same manner as in Example 1 except that the core-shell polymer composition (M-4) was used instead of the core-shell polymer composition (M-1), blended together with vinyl chloride and other compounding agents in an amount of 5.8 parts. The results are shown in Table 3.

### EXAMPLE 16

The specific viscosity (ηₛₚ) was measured in the same manner as in Example 1 by using the powdery core-shell polymer (A-9) of Example 15 instead of the core-shell polymer composition (M-1). Evaluation was carried out in the same manner as in Example 1 except that 5.63 parts of powdery core-shell polymer (A-9) and 0.17 part of sodium lauryl sulfate were used instead of the core-shell polymer composition (M-1), blended together with vinyl chloride and other compounding agents. The results are shown in Table 3.

### EXAMPLE 17

After adding 3 parts of sodium lauryl sulfate to the core-shell polymer latex (G-5) of Example 14, the latex was subjected to spray drying with an inlet temperature of 140° C. and an outlet temperature of 60° C., instead of coagulation, to prepare powdery core-shell polymer (A-10). Evaluation was carried out in the same manner as in Example 1 except that this core-shell polymer (A-10) was used instead of the core-shell polymer composition (M-1), blended together with vinyl chloride and other compounding agents in an amount of 5.8 parts. The results are shown in Table 3.

### COMPARATIVE EXAMPLE 7

By repeating the procedure of dispersing the core-shell polymer (A-8) of Example 14 in 30 times in weight of methanol, stirring and then washing by suction filtration 4 times, the anionic surfactant was removed. After drying, the washed core-shell polymer composition (M-5) was obtained. Evaluation was carried out in the same manner as in Example 1 except that this core-shell polymer composition (M-5) was used instead of the core-shell polymer composition (M-1), blended together with vinyl chloride and other compounding agents in an amount of 5.8 parts. The results are shown in Table 3.

### COMPARATIVE EXAMPLE 8

Evaluation was carried out in the same manner as in Example 1 except that the powdery core-shell polymer (A-9) of Example 15 was used instead of the core-shell polymer composition (M-1), blended together with vinyl chloride and other compounding agents in an amount of 5.8 parts. The results are shown in Table 3.

### EXAMPLE 18

As to the mixture used for preparing the acrylic rubber latex (R-1) of Example 1, a mixed solution containing 81 parts of butyl acrylate, 18.4 parts by weight of n-octyl acrylate, 0.6 part of allyl methacrylate and 0.2 part of cumene hydroperoxide was used instead of a mixed solution containing 99 parts of butyl acrylate, 0.6 part of allyl methacrylate and. 0.2 part of cumene hydroperoxide, and an acrylic rubber latex (R-5) having an average particle size of 0.14 μm and a glass transition temperature of −45° C. was obtained. Using this acrylic rubber latex (R-5) instead of acrylic rubber latex (R-1), core-shell polymer latex (G-6) was obtained. The glass transition temperature of the rubbery polymer of the shell was 78° C. Evaluation was carried out in the same manner as in Example 4 except that the core-shell polymer latex (G-6) was used instead of the core-shell polymer latex (G-1). The results are shown in Table 4.

### EXAMPLE 19

An acrylic rubber latex (R-6) having an average particle size of 0.15 μm and a glass transition temperature of −47° C. was obtained by using 2-ethylhexyl acrylate instead of octyl acrylate used in Example 18. Using this acrylic rubber latex (R-6) instead of acrylic rubber latex (R- 1), core-shell polymer latex (G-7) was obtained as in Example 1. Evaluation was carried out in the same manner as in Example 4 except that the core-shell polymer latex (G-7) was used instead of the core-shell polymer latex (G- 1). The results are shown in Table 4.

### COMPARATIVE EXAMPLES 9 AND 10

Evaluation was carried out in the same manner as in Examples 18 and 19 except that sodium lauryl sulfate was not added immediately after the polymerization of core-shell polymer latex (G-6) or (G-7). The results are shown in Table 4.

### EXAMPLE 20

70 parts of butyl acrylate, 29.5 parts of stearyl methacrylate and 0.5 part of allyl methacrylate were mixed to obtain 100 parts of a monomer mixture. The monomer mixture was added to 300 parts of distilled water in which 1 part of dipotassium alkenyl succinate in an amount of 100 parts. After preparatory stirring by using a homomixer at a rate of 10,000 rpm, emulsifying and dispersing were conducted at a pressure of 300 kg/cm² by using a homogenizer, and a (meth)acrylate emulsion was obtained. This mixture was then transferred to a pressure polymerization reactor equipped with a stirrer and the temperature was elevated to 70° C. with stirring. The air inside the reactor was then replaced with nitrogen, and the pressure was reduced. After adding 1.5 parts of potassium persulfate dissolved into a small amount of distilled water, the system was then left alone at 70° C. for 5 hours, and polymerization was completed. An acrylic rubber latex (R-7) having a glass transition temperature of −70° C. and an average particle size of 0.16 μm was obtained. 70 parts of the acrylic rubber latex (R-7) in solid content was transferred to the pressure polymerization reactor equipped with a stirrer and the temperature was elevated to 56° C. with stirring. The air inside the reactor was then replaced with nitrogen, and the pressure was reduced. Thereto was added a mixed solution of 27 parts of methyl methacrylate, 3 parts of 2-ethyl hexyl acrylate and 0.0075 part of t-butyl hydroperoxide all at once. Furthermore, 0.0004 part of ferrous sulfate (FeSO₄.7H₂O) dissolved into a small amount of water and 0.001 part of EDTA•2Na salt were added, and then 0.1 part of sodium formaldehyde sulfoxylate dissolved into a small amount of distilled water was added. After 1 hour, 0.02 part of t-butyl hydroperoxide was added, and 1 hour of post-polymerization was conducted. A core-shell polymer latex (G-8) having an average particle size of 0.18 μm was obtained. The glass transition temperature of the rubbery polymer of the shell was 76° C. The obtained core-shell polymer latex (G-8) was coagulated with calcium chloride, then heat-treated, cooled to 10° C., and subjected to dehydration and drying to prepare powdery core-shell polymer (A-11). Subsequently, the core-shell polymer composition (M-6) was obtained by mixing the core-shell polymer (A-11) and sodium lauryl sulfate in a weight ratio of 96.5/3.5 using a blender. Evaluation was carried out in the same manner as in Example 1 except that the core-shell polymer composition (M-6) was used instead of the core-shell polymer composition (M-1). The results are shown in Table 5.

### EXAMPLE 21

Evaluation was carried out in the same manner as in Example 20 except that a monomer mixture of 59.5 parts of butyl acrylate, 40 parts of lauryl methacrylate, and 0.5 part of allyl methacrylate was used in the polymerization of acrylic rubber latex (R-7). The average particle size of the obtained acrylic rubber latex was 0.15 μm and the glass transition temperature was −58° C. The results are shown in Table 5.

### EXAMPLE 22

Evaluation was carried out in the same manner as in Example 20 except that a monomer mixture of 59.5 parts of butyl acrylate, 40 parts of lauryl acrylate, and 0.5 part of allyl methacrylate was used in the polymerization of acrylic rubber latex (R-7). The average particle size of the obtained acrylic rubber latex was 0.14 μm and the glass transition temperature was −36° C. The results are shown in Table 5.

### EXAMPLE 23

Evaluation was carried out in the same manner as in Example 20 except that a monomer mixture of 79.5 parts of butyl acrylate, 20 parts of stearyl acrylate, and 0.5 part of allyl methacrylate was used in the polymerization of acrylic rubber latex (R-7). The average particle size of the obtained acrylic rubber latex was 0.14 μm and the glass transition temperature was −46° C. The results are shown in Table 5.

### COMPARATIVE EXAMPLES 11 TO 14

Evaluation was carried out in the same manner as in Examples 20 to 23 except that only core-shell polymer (A-11) was used instead of core-shell polymer composition (M-6). The results are shown in Table 5.

### COMPARATIVE EXAMPLES 15 TO 18

Evaluation was carried out in the same manner as in Example 1 except that commercially available hydroxy stearic acid (Comparative Example 15), low molecular weight polyethylene wax (Comparative Example 16), paraffin wax (Comparative Example 17) and dibasic fatty acid ester (Comparative Example 18) was used instead of sodium lauryl sulfate. The results are shown in Table 6.

### EXAMPLE 24

7 parts of the core-shell polymer composition (M-1) was blended with 4.5 parts of calcium-zinc stabilizer (available from Asahi Denka Kogyo KK, product name: ADEK STAB RX-212), 0.5 parts of lubricant (available from Asahi Denka Kogyo KK, product name: ADEK STAB RX-505), 3 parts of titanium oxide (pigment, available from Sakai Chemical Industry Co., Ltd., product name: TITONE R650), 5 parts of calcium carbonate (filler, available from OMYA Co., Ltd., product name: OMYACARB UFT), 0.5 part of processing aid (available from Kaneka Corporation, product name: PA-20) and 100 parts of vinyl chloride (available from Kaneka Corporation, product name: S-1001, polymerization degree: 1,000). The mixture was then extruded under the following molding conditions and formed into a board 3 mm in thickness.

(Molding Condition)

Molding machine: Conical Molding Machine TEC-55DV made by Toshiba Machine Co., Ltd., 3 mm slit die

Molding temperature: C1/C2/C3/C4/AD/D1/D2: 185/185/185/175/178/190/190 (° C.)

Rotation number of screw: 30 rpm

The extrusion load and throughput in molding are shown in Table 7.

Then by using the obtained board, the Charpy strength was evaluated in accordance with JIS K7111. The obtained Charpy strength value is shown in Table 7.

By using the same compound as that used in the extrusion molding, the plasticization test was carried out under the following test conditions.

(Plasiticization test)

Machine: Labo Plastomill Model 20C200 made by Toyo Seiki Co., Ltd., Chamber

Rotation number of rotor: 30 rpm

Testing temperature: 170° C.

Amount to be filled: 74 g

Testing time: 40 minutes

The results of estimating the equilibrium torque value and resin temperature at which the equilibrium torque is reached, according to the time-torque curve obtained in the test, are shown in Table 7.

### COMPARATIVE EXAMPLE 19

Evaluation was conducted in the same manner as in Example 24 except that only the core-shell polymer (A-1) of Example 1 used instead of core-shell polymer composition (M-1). The results are shown in Table 7.

### EXAMPLE 25

7 parts of the core-shell polymer composition (M-1) of Example 1 was blended with 3 parts of basic lead phosphite (stabilizer·lubricant, available from Sakai Chemical Industry Co., Ltd., product name: DLP), 1 part of lead stearate (stabilizer·lubricant, available from Sakai Chemical Industry Co., Ltd., product name: SL-1000), 0.5 part of calcium stearate (lubricant, available from Sakai Chemical Industry Co., Ltd., product name: SC-100), 0.5 part of unsaturated fatty acid ester (lubricant, available from Cognis Co., Ltd., product name: Loxiol G-32), 3 parts of titanium oxide (pigment, available from Sakai Chemical Industry Co., Ltd., product name: TITONE R650), 5 parts of calcium carbonate (filler, available from OMYA Co., Ltd., product name: OMYACARB UFT), 0.5 part of processing aid (available from Kaneka Corporation, product name: PA-20) and 100 parts of vinyl chloride (available from Kaneka Corporation, product name: S-1001, polymerization degree: 1,000). The mixture was then extruded under the following molding conditions and formed into a board 3 mm in thickness.

(Molding Condition)

Molding machine: Conical Molding Machine TEC-55DV made by Toshiba Machine Co., Ltd., 3 mm slit die

Molding temperature: C1/C2/C3/C4/AD/D1/D2: 185/185/180/175/178/192/192 (° C.)

Rotation number of screw: 30 rpm

The extrusion load and throughput in molding are shown in Table 7.

Then by using the obtained board, the Charpy strength was evaluated in accordance with JIS K7111. The obtained Charpy strength value is shown in Table 7.

By using the same compound as that used in the extrusion molding, the plasticization test was carried out under the following test conditions.

(Plasiticization Test)

Machine: Labo Plastomill Model 20C200 made by Toyo Seiki Co., Ltd., Chamber

Rotation number of rotor: 30 rpm

Testing temperature: 170° C.

Amount to be filled: 76 g

Testing time: 40 minutes

The results of estimating the equilibrium torque value and resin temperature at which the equilibrium torque is reached, according to the time-torque curve obtained in the test, are shown in Table 7.

### COMPARATIVE EXAMPLE 20

Evaluation was conducted in the same manner as in Example 25 except that only the core-shell polymer (A-1) of Example 1 was used instead of core-shell polymer composition (M-1). The results are shown in Table 7.

Tables 1 to 7 show that not only does the vinyl chloride resin composition of the present invention have extremely good impact resistance, but also excellent processability, that is the load on the extruder is small, and excellent productivity (extrusion amount per unit time), and in addition, that the heat generation by the shearing of the melted resin, which may trigger burning, is small.

TABLE 1

| | Graft copolymer (A) | | | | |
|---|---|---|---|---|---|
| | Composition | | | | |
| | of core | Composition of | | | |
| | component | shell component | | | |
| Ex. No. | (part) | (part) | Acid or anionic surfactant (B) | (A)/(B) | Method of mixing (A) and (B) |
| 1 | BA (65) | MMA (32)/BA (3) | Sodium lauryl sulfate | 97/3 | Mixing in the form of powder |
| 2 | BA (65) | MMA (32)/BA (3) | Calcium lauryl sulfate | 97.2/2.8 | Mixing when polymerizing (A) |
| 3 | BA (65) | MMA (32)/BA (3) | Calcium lauryl sulfate | 96/4 | Adding to Lx obtained by polymerizing |
| | | | | | (A), before coagulation |
| 4 | BA (65) | MMA (32)/BA (3) | Sodium lauryl sulfate | 96/4 | Adding to Lx obtained by polymerizing |
| | | | | | (A), before spray drying |
| 5 | BA (65) | MMA (32)/BA (3) | RO(CH₂CH₂O)₄—P(═O)(OH)₂ | 94/6 | Mixing when blending |
| | | | (R═C₁₈H₃₇) | | |
| 6 | BA (65) | MMA (32)/BA (3) | [RO(CH₂CH₂O)₄]₂—P(═O)OH | 94/6 | Mixing when blending |
| | | | (R═C₁₀H₂₁) | | |
| 7 | BA (65) | MMA (32)/BA (3) | RO(CH₂CH₂O)₄—P(═O)(OH)₂ | 94/6 | Mixing when blending |
| | | | (R═C₁₂H₂₅(C₆H₄)) | | |
| 8 | BA (65) | MMA (32)/BA (3) | Sodium dioctyl sulfosuccinate | 94/6 | Mixing when blending |
| Com. Ex. 1 | BA (65) | MMA (32)/BA (3) | — | 100/0 | — |
| Com. Ex. 2 | BA (65) | MMA (32)/BA (3) | Sodium lauryl sulfate | 99.9/0.1 | Mixing in the form of powder |
| Com. Ex. 3 | BA (65) | MMA (32)/BA (3) | Sodium lauryl sulfate | 80/20 | Mixing in the form of powder |
| Com. Ex. 4 | BA (65) | MMA (32)/BA (3) | Sodium lauryl sulfate | 96/4 | Adding to Lx obtained by polymerizing |
| | | | | | (A), before spray drying |
| Com. Ex. 5 | BA (38.4)/ | MMA (32)/BA (3) | Sodium lauryl sulfate | 96/4 | Adding to Lx obtained by polymerizing |
| | St (26.3) | | | | (A), before spray drying |

| | | | | | Labo Plastomill melting experiment | | | |
|---|---|---|---|---|---|---|---|---|
| | | | Extrusion molding | | | Resin temperature | Gardner | Izod |
| | | Ratio | Load | Throughput | Equilibrium torque | at equilibrium area | strength | strength |
| Ex. No. | ηₛₚ | (α) | (A) | (kg/hr) | (N · m) | (° C.) | (inch · lbs/mil) | (kJ/m²) |
| 1 | 0.21 | 8.3 | 51 | 81 | 36 | 179 | 2.8 | 85 |
| 2 | 0.20 | 8.3 | 54 | 72 | 38 | 179.5 | 2.6 | 79 |
| 3 | 0.21 | 8.3 | 53 | 75 | 36 | 179 | 2.7 | 76 |
| 4 | 0.21 | 8.3 | 51 | 83 | 36 | 178.5 | 3.2 | 87 |
| 5 | 0.21 | 8.3 | 53 | 79 | 38 | 179.5 | 2.9 | 86 |
| 6 | 0.21 | 8.3 | 52 | 80 | 39 | 179 | 2.8 | 88 |
| 7 | 0.21 | 8.3 | 50 | 81 | 37 | 179 | 2.7 | 76 |
| 8 | 0.21 | 8.3 | 54 | 78 | 38 | 179 | 2.8 | 86 |
| Com. Ex. 1 | 0.21 | 8.3 | 69 | 60 | 45 | 184 | 2.1 | 88 |
| Com. Ex. 2 | 0.21 | 8.3 | 69 | 59 | 44.5 | 184 | 2.2 | 83 |
| Com. Ex. 3 | 0.21 | 8.3 | 40 | 85 | — | — | 0.5 | 8 |
| Com. Ex. 4 | 0.06 | 10.0 | 50 | 81 | 35 | 177.5 | 1.2 | 14 |
| Com. Ex. 5 | 0.22 | 8.3 | 53 | 79 | 37 | 178 | 0.3 | 11 |

TABLE 2

| | Graft copolymer (A) | | | | |
|---|---|---|---|---|---|
| | Composition | | | | |
| | of core | Composition of | | | |
| | component | shell component | | | |
| Ex. No. | (part) | (part) | Acid or anionic surfactant (B) | (A)/(B) | Method of mixing (A) and (B) |
| 9 | BA (70) | MMA (25)/BMA (5) | Calcium lauryl sulfate | 96.7/3.3 | When polymerizing (A) and adding |
| | | | | | to Lx obtained by polymerization, |
| | | | | | before coagulation |
| 10 | BA (70) | MMA (25)/BMA (5) | Calcium lauryl sulfate | 99.2/0.8 | When polymerizing (A) |
| 11 | BA (70) | MMA (25)/BMA (5) | Calcium lauryl sulfate, | 96.7/3.3 | When polymerizing (A) and |
| | | | Sodium lauryl sulfate | | mixing in the form of powder |
| 12 | BA (70) | MMA (25)/BMA (5) | Calcium lauryl sulfate, | 96.7/3.3 | When polymerizing (A) and blending |
| | | | Sodium lauryl sulfate | | |
| 13 | BA (70) | MMA (25)/BMA (5) | Sodium lauryl sulfate | 96.7/3.3 | When polymerizing (A) and adding |
| | | | | | to Lx obtained by polymerization, |
| | | | | | before spray drying |
| Com. Ex. 6 | BA (70) | MMA (25)/BMA (5) | — | 100/0 | — |

| | | | | | Labo Plastomill melting experiment | | | |
|---|---|---|---|---|---|---|---|---|
| | | | Extrusion molding | | | Resin temperature | Gardner | Izod |
| | | Ratio | Load | Throughput | Equilibrium torque | at equilibrium area | strength | strength |
| Ex. No. | ηₛₚ | (α) | (A) | (kg/hr) | (N · m) | (° C.) | (inch · lbs/mil) | (kJ/m²) |
| 9 | 0.31 | 8.5 | 55 | 78 | 40 | 179.5 | 2.6 | 97 |
| 10 | 0.31 | 8.5 | 58 | 72 | 43 | 180 | 2.8 | 93 |
| 11 | 0.32 | 8.5 | 51 | 79 | 34 | 178 | 2.7 | 98 |
| 12 | 0.31 | 8.5 | 52 | 83 | 35 | 178 | 2.9 | 88 |
| 13 | 0.31 | 8.5 | 50 | 82 | 38 | 179.5 | 2.9 | 86 |
| Com. Ex. 6 | 0.31 | 8.5 | 75 | 60 | 46 | 184.5 | 2.1 | 49 |

TABLE 3

| | Graft copolymer (A) | | | | |
|---|---|---|---|---|---|
| | Composition | | | | |
| | of core | Composition of | | | |
| | component | shell component | | | |
| Ex. No. | (part) | (part) | Acid or anionic surfactant (B) | (A)/(B) | Method of mixing (A) and (B) |
| 14 | BA (70) | MMA (25)/BMA (5) | Calcium lauryl sulfate | 97.0/3.0 | When polymerizing (A) and adding |
| | | | | | to Lx obtained by polymerization, |
| | | | | | before coagulation |
| 15 | BA (70) | MMA (25)/BMA (5) | Calcium lauryl sulfate, | 97.0/3.0 | When polymerizing (A) and |
| | | | Sodium lauryl sulfate | | mixing in the form of powder |
| 16 | BA (70) | MMA (25)/BMA (5) | Calcium lauryl sulfate, | 97.0/3.0 | When polymerizing (A) and blending |
| | | | Sodium lauryl sulfate | | |
| 17 | BA (70) | MMA (25)/BMA (5) | Sodium lauryl sulfate | 97.0/3.0 | When polymerizing (A) and adding |
| | | | | | to Lx obtained by polymerization, |
| | | | | | before spray drying |
| Com. Ex. 7 | BA (70) | MMA (25)/BMA (5) | — | 100/0 | — |
| Com. Ex. 8 | BA (70) | MMA (25)/BMA (5) | Calcium lauryl sulfate | 99.9/0.1 | When polymerizing (A) |

| | | | | | Labo Plastomill melting experiment | | | |
|---|---|---|---|---|---|---|---|---|
| | | | Extrusion molding | | | Resin temperature | Gardner | Izod |
| | | Ratio | Load | Throughput | Equilibrium torque | at equilibrium area | strength | strength |
| Ex. No. | ηₛₚ | (α) | (A) | (kg/hr) | (N · m) | (° C.) | (inch · lbs/mil) | (kJ/m²) |
| 14 | 0.29 | 8.1 | 54 | 76 | 40 | 179 | 2.4 | 99 |
| 15 | 0.29 | 8.1 | 52 | 81 | 36 | 178.5 | 2.7 | 94 |
| 16 | 0.29 | 8.1 | 51 | 80 | 35 | 178.5 | 2.7 | 101 |
| 17 | 0.28 | 8.1 | 49 | 81 | 35 | 178 | 3.1 | 98 |
| Com. Ex. 7 | 0.29 | 8.1 | 73 | 59 | 45 | 184 | 1.9 | 61 |
| Com. Ex. 8 | 0.29 | 8.1 | 72 | 61 | 45 | 184.5 | 2.1 | 54 |

TABLE 4

| | Graft copolymer (A) | | | | |
|---|---|---|---|---|---|
| | Composition | | | | |
| | of core | Composition of | | | |
| | component | shell component | | | |
| Ex. No. | (part) | (part) | Acid or anionic surfactant (B) | (A)/(B) | Method of mixing (A) and (B) |
| 4 | BA (65) | MMA (32)/BA (3) | Sodium lauryl sulfate | 96/4 | Adding to Lx obtained by |
| | | | | | polymerizing (A), before spray drying |
| 18 | BA (53.3)/nOA | MMA (32)/BA (3) | Sodium lauryl sulfate | 96/4 | Adding to Lx obtained by |
| | (11.7) | | | | polymerizing (A), before spray drying |
| 19 | BA (53.3)/ | MMA (32)/BA (3) | Sodium lauryl sulfate | 96/4 | Adding to Lx obtained by |
| | 2EHA (11.7) | | | | polymerizing (A), before spray drying |
| Com. Ex. 9 | BA (53.3)/nOA | MMA (32)/BA (3) | — | 100/0 | — |
| | (11.7) | | | | |
| Com. Ex. 10 | BA (53.3)/ | MMA (32)/BA (3) | — | 100/0 | — |
| | 2EHA (11.7) | | | | |

| | | | | | Labo Plastomill melting experiment | | | |
|---|---|---|---|---|---|---|---|---|
| | | | Extrusion molding | | | Resin temperature | Gardner | Izod |
| | | Ratio | Load | Throughput | Equilibrium torque | at equilibrium area | strength | strength |
| Ex. No. | ηₛₚ | (α) | (A) | (kg/hr) | (N · m) | (° C.) | (inch · lbs/mil) | (kJ/m²) |
| 4 | 0.21 | 8.3 | 51 | 83 | 36 | 178.5 | 3.2 | 87 |
| 18 | 0.24 | 8.6 | 52 | 81 | 38 | 179.5 | 3.4 | 110 |
| 19 | 0.26 | 8.1 | 51 | 78 | 37 | 179.5 | 3.5 | 107 |
| Com. Ex. 9 | 0.24 | 8.6 | 76 | 60 | 46 | 184 | 2.9 | 102 |
| Com. Ex. 10 | 0.26 | 8.1 | 74 | 59 | 47 | 184 | 3.2 | 94 |

TABLE 5

| | Graft copolymer (A) | | | | |
|---|---|---|---|---|---|
| | Composition | | | | |
| | of core | Composition of | | | |
| | component | shell component | | | |
| Ex. No. | (part) | (part) | Acid or anionic surfactant (B) | (A)/(B) | Method of mixing (A) and (B) |
| 4 | BA (65) | MMA (32)/BA (3) | Sodium lauryl sulfate | 96/4 | Adding to Lx obtained by |
| | | | | | polymerizing (A), before spray drying |
| 20 | BA (49)/ | MMA (27)/2EHA (3) | Sodium lauryl sulfate | 96.5/3.5 | Mixing in the form of powder |
| | SMA (20.65) | | | | |
| 21 | BA (41.65)/ | MMA (27)/2EHA (3) | Sodium lauryl sulfate | 96.5/3.5 | Mixing in the form of powder |
| | LMA (28) | | | | |
| 22 | BA (41.65)/ | MMA (27)/2EHA (3) | Sodium lauryl sulfate | 96.5/3.5 | Mixing in the form of powder |
| | LA (28) | | | | |
| 23 | BA (55.65)/ | MMA (27)/2EHA (3) | Sodium lauryl sulfate | 96.5/3.5 | Mixing in the form of powder |
| | SA (14) | | | | |
| Com. Ex. 11 | BA (49)/ | MMA (27)/2EHA (3) | — | 100/0 | — |
| | SMA (20.65) | | | | |
| Com. Ex. 12 | BA (41.65)/ | MMA (27)/2EHA (3) | — | 100/0 | — |
| | LMA (28) | | | | |
| Com. Ex. 13 | BA (41.65)/ | MMA (27)/2EHA (3) | — | 100/0 | — |
| | LA (28) | | | | |
| Com. Ex. 14 | BA (55.65)/ | MMA (27)/2EHA (3) | — | 100/0 | — |
| | SA (14) | | | | |

| | | | | | Labo Plastomill melting experiment | | | |
|---|---|---|---|---|---|---|---|---|
| | | | Extrusion molding | | | Resin temperature | Gardner | Izod |
| | | Ratio | Load | Throughput | Equilibrium torque | at equilibrium area | strength | strength |
| Ex. No. | ηₛₚ | (α) | (A) | (kg/hr) | (N · m) | (° C.) | (inch · lbs/mil) | (kJ/m²) |
| 4 | 0.21 | 8.3 | 51 | 83 | 36 | 178.5 | 3.2 | 87 |
| 20 | 0.30 | 12.4 | 52 | 79 | 37 | 179.5 | 3.1 | 75 |
| 21 | 0.28 | 13.5 | 54 | 84 | 35 | 179.5 | 3.1 | 89 |
| 22 | 0.28 | 13.9 | 53 | 82 | 36 | 179 | 3.3 | 94 |
| 23 | 0.26 | 12.1 | 51 | 81 | 35 | 177.5 | 2.9 | 79 |
| Com. Ex. 11 | 0.30 | 12.4 | 72 | 56 | 46 | 183 | 2.3 | 38 |
| Com. Ex. 12 | 0.28 | 13.5 | 74 | 56 | 44 | 184 | 3.1 | 65 |
| Com. Ex. 13 | 0.28 | 13.9 | 73 | 58 | 47 | 184.5 | 3.3 | 83 |
| Com. Ex. 14 | 0.26 | 12.1 | 71 | 59 | 47 | 183 | 2.9 | 51 |

TABLE 6

| | Graft copolymer (A) | | | | |
|---|---|---|---|---|---|
| | Composition | | | | |
| | of core | Composition of | | | |
| | component | shell component | | | |
| Ex. No. | (part) | (part) | Acid or anionic surfactant (B) | (A)/(B) | Method of mixing (A) and (B) |
| 1 | BA (65) | MMA (32)/BA (3) | Sodium lauryl sulfate | 97/3 | Mixing in the form of powder |
| Com. Ex. 15 | BA (65) | MMA (32)/BA (3) | Hydroxy stearic acid | 97/3 | Mixing in the form of powder |
| Com. Ex. 16 | BA (65) | MMA (32)/BA (3) | Low molecular weight | 97/3 | Mixing in the form of powder |
| | | | polyethylene wax | | |
| Com. Ex. 17 | BA (65) | MMA (32)/BA (3) | Paraffin | 97/3 | Mixing in the form of powder |
| Com. Ex. 18 | BA (65) | MMA (32)/BA (3) | Dibasic fatty acid ester | 97/3 | Mixing in the form of powder |

| | | | | | Labo Plastomill melting experiment | | | |
|---|---|---|---|---|---|---|---|---|
| | | | Extrusion molding | | | Resin temperature | Gardner | Izod |
| | | Ratio | Load | Throughput | Equilibrium torque | at equilibrium area | strength | strength |
| Ex. No. | ηₛₚ | (α) | (A) | (kg/hr) | (N · m) | (° C.) | (inch · lbs/mil) | (kJ/m²) |
| 1 | 0.21 | 8.3 | 51 | 81 | 36 | 179 | 2.8 | 85 |
| Com. Ex. 15 | 0.21 | 8.3 | 49 | 66 | 42 | 180 | 0.4 | 12 |
| Com. Ex. 16 | 0.21 | 8.3 | 53 | 66 | 37 | 178.5 | 0.4 | 11 |
| Com. Ex. 17 | 0.21 | 8.3 | 62 | 61 | 34 | 178 | 0.3 | 9 |
| Com. Ex. 18 | 0.21 | 8.3 | 54 | 58 | 41 | 180 | 1.1 | 14 |

TABLE 7

| | Graft copolymer (A) | | | | |
|---|---|---|---|---|---|
| | Composition | | | | |
| | of core | Composition of | | | |
| | component | shell component | | | |
| Ex. No. | (part) | (part) | Acid or anionic surfactant (B) | (A)/(B) | Method of mixing (A) and (B) |
| 24 | BA (65) | MMA (32)/BA (3) | Sodium lauryl sulfate | 97/3 | Mixing in the form of powder |
| 25 | BA (65) | MMA (32)/BA (3) | Sodium lauryl sulfate | 97/3 | Mixing in the form of powder |
| Com. Ex. 19 | BA (65) | MMA (32)/BA (3) | — | 100/0 | — |
| Com. Ex. 20 | BA (65) | MMA (32)/BA (3) | — | 100/0 | — |

| | | | | | Labo Plastomill melting experiment | | | |
|---|---|---|---|---|---|---|---|---|
| | | | Extrusion molding | | | Resin temperature | Gardner | Izod |
| | | Ratio | Load | Throughput | Equilibrium torque | at equilibrium area | strength | strength |
| Ex. No. | ηₛₚ | (α) | (A) | (kg/hr) | (N · m) | (° C.) | (inch · lbs/mil) | (kJ/m²) |
| 24 | 0.21 | 8.3 | Ca/Zn | 56 | 78 | 37 | 179 | 105 |
| 25 | 0.21 | 8.3 | Pb | 53 | 76 | 37 | 180 | 110 |
| Com. Ex. 19 | 0.21 | 8.3 | Ca/Zn | 80 | 55 | 44 | 183 | 85 |
| Com. Ex. 20 | 0.21 | 8.3 | Pb | 80 | 58 | 43 | 184 | 102 |

### INDUSTRIAL APPLICABILITY

The vinyl chloride resin composition comprising the core-shell polymer composition of the present invention is excellent not only in weatherability and impact resistance but also processability. In other words, kneading can be advanced to a sufficient degree to process with a small load on the molding machine and therefore dimensional stability is excellent. In addition, because the melt viscosity is suitably maintained during molding, faulty appearance due to melt fracture or the like is not caused. Furthermore, because the heat generation by the shearing of the melted resin is small and molding at a low temperature is possible, problems such as burning and a decrease in heat stability do not occur.

1. A core-shell polymer composition comprising:
(A) 85 to 99.4% by weight of a core-shell polymer containing a rubbery polymer having a glass transition temperature of at most 0° C. in the core or the shell,
(B) 15 to 0.6% by weight of at least one acid or anionic surfactant selected from the group consisting of alkyl sulfates, salts of alkyl sulfofatty acid ester, alkyl sulfonates, alkyl phosphates or salts thereof and alkyl phosphites or salts thereof
((A) and (B) amounting to 100% by weight in total),
said core-shell polymer having a specific viscosity (ηₛₚ) of at least 0.19 when measured at 30° C. by using a 0.2 g/100 ml acetone solution of a portion soluble in methyl ethyl ketone and insoluble in methanol of said core-shell polymer.

2. The core-shell polymer composition of claim 1, wherein the glass transition temperature of said rubbery polymer is at most −20° C.

3. The core-shell polymer composition of claim 1, wherein the core of the core-shell polymer (A) is a rubbery polymer obtained by polymerizing a monomer mixture comprising 45 to 99.95% by weight of alkyl acrylate, which has an alkyl group having 2 to 18 carbon atoms, 0 to 40% by weight of alkyl methacrylate, which has an alkyl group having 4 to 22 carbon atoms, 0.05 to 5% by weight of a multifunctional monomer and 0 to 10% by weight of a monomer copolymerizable therewith (100% by weight in total).

4. The core-shell polymer composition of claim 1, wherein the core of the core-shell polymer (A) is a rubbery polymer obtained by polymerizing a monomer mixture comprising 95 to 99.9% by weight of alkyl acrylate, which has an alkyl group having 2 to 12 carbon atoms, and 0.1 to 5% by weight of a multifunctional monomer (100% by weight in total).

5. The core-shell polymer composition of claim 1, wherein at least one shell layer of the core-shell polymer (A) is a polymer obtained by polymerizing a monomer or monomer mixture comprising:
40 to 100% by weight of methyl methacrylate,
0 to 60% by weight of at least one monomer or monomer mixture selected from the group consisting of alkyl acrylate, which has an alkyl group having 1 to 18 carbon atoms, alkyl methacrylate, which has an alkyl group having 2 to 18 carbon atoms, unsaturated nitrile and aromatic vinyl compound, and
0 to 10% by weight of a monomer copolymerizable therewith.

6. The core-shell polymer composition of claim 1, wherein at least one shell layer of the core-shell polymer (A) is a polymer obtained by polymerizing a monomer or monomer mixture comprising:
40 to 100% by weight of methyl methacrylate, and
0 to 60% by weight of at least one monomer or monomer mixture selected from the group consisting of alkyl acrylate, which has an alkyl group having 1 to 12 carbon atoms, and alkyl methacrylate, which has an alkyl group having 2 to 8 carbon atoms.

7. The core-shell polymer composition of claim 1, wherein said portion soluble in methyl ethyl ketone and insoluble in methanol has a specific viscosity of 0.2 to 1 when measured in 0.2 g/100 ml acetone solution at 30° C.

8. The core-shell polymer composition of claim 1, wherein said core-shell polymer composition contains said portion soluble in methyl ethyl ketone and insoluble in methanol in an amount of at least 2% by weight based on 100% by weight of the core-shell polymer (A).

9. The core-shell polymer composition of claim 1, wherein said core-shell polymer (A) is a polymer obtained by polymerizing at least one monomer or monomer mixture for said shell in one step or at least two steps in the presence of a core polymer which is in latex state.

10. The core-shell polymer composition of claim 1, wherein said alkyl group of said acid or anionic surfactant (B) is a saturated or unsaturated hydrocarbon group having 8 to 20 carbon atoms.

11. The core-shell polymer composition of claim 1, wherein said acid or anionic surfactant (B) is higher alcohol sulfate.

12. The core-shell polymer composition of claim 1, wherein said acid or anionic surfactant (B) is dialkyl sulfosuccinate.

13. The core-shell polymer composition of claim 1, wherein said acid or anionic surfactant (B) is acidic alkylpolyoxyalkylene phosphate.

14. The core-shell polymer composition of claim 1, wherein said acid or anionic surfactant (B) is an alkali metal salt or an ammonium salt.

15. The core-shell polymer composition of claim 1, which contains 1 to 12% by weight of said acid or anionic surfactant (B).

16. The core-shell polymer composition of claim 15, which contains 2.3 to 10% by weight of said acid or anionic surfactant (B).

17. The core-shell polymer composition of claim 16, which contains 2.8 to 8.5% by weight of said acid or anionic surfactant (B).

18. A process for preparing the core-shell polymer composition of claim 1, which comprises conducting emulsion-polymerization by using said acid or anionic surfactant (B) to obtain said core-shell polymer (A).

19. A process for preparing the core-shell polymer composition of claim 1, which comprises carrying out coagulation or spray drying after adding said acid or anionic surfactant (B) to said core-shell polymer (A) which is in a latex state.

20. A process for preparing the core-shell polymer composition of claim 1, which comprises mixing said acid or anionic surfactant (B) to said core-shell polymer (A) which is in a state of powder or pellet.

21. A vinyl chloride resin composition comprising 1 to 30 parts by weight of the core-shell polymer composition of claim 1 based on 100 parts by weight of a vinyl chloride resin (C).

22. A product obtained by molding the vinyl chloride resin composition of claim 21.
